(19) United States
(12) Patent Application Publication
(10) Pub. No.: US 2025/0184341 A1
(43) Pub. Date: Jun. 5, 2025

(54) DETECTING ACCOUNT TAKEOVER

(71) Applicant: Abnormal Security Corporation, San Francisco, CA (US)

(72) Inventors: Tejas Khot, Long Island City, NY (US); Umut Gultepe, San Francisco, CA (US); David Hagar, London (GB); Erin Elisabeth Edkins Ludert, San Francisco, CA (US); Elizabeth Law, San Francisco, CA (US); Cheng-Lin Yeh, San Francisco, CA (US); Mark Steffan Philip, Seattle, WA (US); Nirmal Balachundhar, San Francisco, CA (US); Sanjay Jeyakumar, El Cerrito, CA (US)

(21) Appl. No.: 18/962,240

(22) Filed: Nov. 27, 2024

Related U.S. Application Data
(60) Provisional application No. 63/604,406, filed on Nov. 30, 2023.

(51) Int. Cl. H04L 9/40

(52) U.S. Cl. CPC H04L 63/1425; H04L 63/1441

(57) ABSTRACT

Indications of login events of a computer account, including a plurality of attributes of the login events, are received. Correlations between the plurality of attributes of the login events are tracked. A new indication of a new login event is received. Based at least in part on the tracked correlations and attributes of the new login event, a machine learning model is used to determine a result associated with whether the new login event is anomalous. A computer security action based on the result of the machine learning model is performed.

### CROSS REFERENCE TO OTHER APPLICATIONS

This application claims priority to U.S. Provisional Patent Application No. 63/604,406 entitled DETECTING ACCOUNT TAKEOVER filed Nov. 30, 2023, which is incorporated herein by reference for all purposes.

### BACKGROUND OF THE INVENTION

Account compromise including email account compromise represents one type of business compromise scam. Traditionally, enterprises have protected themselves against these types of scams by employing various defenses, such as anti-spam filters that quarantine malicious emails, intrusion detection rules that flag emails with extensions similar to the domain of the enterprise (e.g., an authentic email whose domain is ABC_Company.com could flag a fraudulent email whose domain is ABC-Company.com), and color coding schemes that cause internal emails to be shown in one color while external emails are shown in another color. As security attacks become more sophisticated, these approaches are unable to discover many instances of accounts being compromised including attacks that originate from within an enterprise. Therefore, there is a need for a threat detection system that can detect sophisticated attacks including attacks associated with account compromise and takeover events.

### BRIEF DESCRIPTION OF THE DRAWINGS

Various embodiments of the invention are disclosed in the following detailed description and the accompanying drawings.

FIG. 1 is a block diagram illustrating an embodiment of a system for security threat detection.

FIG. 2 is a diagram illustrating an embodiment of a multi-tiered approach for information aggregation.

FIG. 3 is a block diagram of an embodiment of a threat detection platform.

FIG. 4 is a block diagram illustrating an embodiment of a system for creating an event queue from events associated with various platforms.

FIG. 5 is a diagram of an embodiment of a threat intelligence system that is utilized by a threat detection platform.

FIG. 6 is a block diagram of an embodiment of a threat detection platform for predicting attacks.

FIG. 7 is a block diagram of an embodiment of a threat detection platform for performing threat intelligence.

FIG. 8 is a block diagram of an embodiment of a threat detection platform for determining a potential threat.

FIG. 9 is a block diagram of an embodiment of a threat detection platform for detecting potential instances of account compromise.

FIG. 10 is a diagram of example computer security actions that can be made by an embodiment of a threat detection platform.

FIG. 11 is a flow chart illustrating an embodiment of a process for determining that an account has been compromised.

FIG. 12 is a flow chart illustrating an embodiment of a process for determining that an account has been compromised.

FIG. 13 is a block diagram illustrating a framework for an embodiment of a threat detection platform for discovering instances of email account compromise.

FIG. 14 is a block diagram illustrating an embodiment of a continuous indexer server for a threat detection platform.

FIG. 15 is a flow chart illustrating an embodiment of a process for scoring a threat posed by a digital activity.

FIG. 16 is a flow chart illustrating an embodiment of a process for detecting an account takeover.

FIG. 17 is a functional diagram illustrating a programmed computer processing system for performing threat detection and remediation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Account takeover detection is disclosed. For example, the disclosed techniques and threat detection system can detect anomalous events associated with account compromise and account takeover attacks. When a user account for a service is compromised, an attempt to take over the account is detected, and countermeasures to minimize the attack are invoked. In some embodiments, a user account is monitored over time and attributes associated with the user are tracked and correlated to determine expected user behavior. For example, login and access events for a computer account are tracked along with attributes associated with the events. Example attributes that are tracked include the Internet Protocol (IP) address, location, and/or Internet Service Provider (ISP) used when a user logs into an account. Other attributes can include available and/or used Multi-Factor Authentication (MFA) devices, access tokens, and/or attributes associated with them such as their age and usage frequency. In some embodiments, combinations of attributes are tracked such as the combination of an IP address and location, the combination of an IP address and ISP, and/or the combination of an IP address, location, and a device used for MFA. Moreover, the attributes can be monitored and tracked for various different windows or intervals of time, such as windows corresponding to the last 7 days, 20 days, 30 days, 1 month, 3 months, 6 months, and 12 months. Based on tracked attributes, trends and/or patterns established by the user can be determined.

In various embodiments, the tracked user data is used to predict anomalous events such as malicious events including attempts to take over an account. Using the learned behavior associated with a user, on subsequent user events, such as a new login event, the attributes associated with the event can be compared to established user trends and/or patterns. For example, the login event attributes can be compared to the attribute patterns for the last 7 days. Other comparison windows can be used as well, for example, to establish whether the login is associated with normal behavior for a particular period of time, such as an out-of-town trip reflected by a recent change in location and an ISP and IP address matching a remote office location, weekday work hours behavior matching attributes associated with the user's local office, or seasonal behavior such as attributes associated with access patterns matching planned holiday periods, among other operating patterns.

In some embodiments, the event attributes are used to detect anomalous events by analyzing the event attribute data using a machine learning model. The machine learning model can predict whether an event, such as a login event, is an anomalous event. For example, a deep learning model can be trained with the tracked attributes and tracked combinations of attributes data. In some embodiments, a deep learning model can receive as input the current event attributes and/or as additional input the tracked attributes and the tracked combinations of attributes. Based on a prediction result, a login event is classified as either anomalous or a normal event. In the event the login event is classified as an anomalous event, one or more computer security actions can be taken. For example, the login event can be blocked, the user account can be suspended, the user account can be required to set up new login credentials such as a new password and/or a new MFA device, an existing MFA device can be revoked, an access token such as an Open Authentication (OAuth) token can be revoked, access to resources such as network resources can be restricted, and/or existing user sessions can be invalidated requiring the user to reauthenticate to gain access, among other security actions. In some embodiments, the computer security action can be performed for the user, for groups associated with the user account, and/or for another set of accounts associated with the user such as by accounts associated with the user's location, ISP, network address, sub-address, or subnetwork. For example, a subnetwork attribute can correspond to a network portion and/or a host portion and be expressed using a subnet mask, using CIDR notation, and/or using another notation. Similarly, computer security actions can be performed based on application clients, application service, software configuration, and/or hardware configuration. In some embodiments, the event attributes are tracked across different services such as by correlating attributes for user accounts of different services for the same user.

In some embodiments, email account compromise is an exploit in which an unauthorized entity (also referred to as an “attacker”) gains access to the email or another service account of an employee of an enterprise (also referred to as a “company”) and then imitates the employee. By stealing the employee's identity, the attacker can defraud the enterprise and its employees, customers, and vendors. Collectively, these individuals may be referred to as the “targets” of the attacker.

Account compromise including email account compromise can take a variety of different forms. In many cases, attackers will focus their efforts on employees who have access to sensitive financial information or who are responsible for financial tasks such as paying invoices or initiating wire transfers. For example, an attacker may mimic the identity of an employee on an enterprise network (also referred to as a “business network” or “corporate network”) to trick a target into providing the account number of a financial account associated with the enterprise. As another example, an attacker may mimic the identity of an employee on an enterprise network to trick the target into sending money to an account associated with the attacker. Using the disclosed techniques and systems, the damage associated with an attack can be minimized. In some embodiments, the attack can be prevented and/or further attacks can be prevented.

In some embodiments, indications of login events of a computer account, including a plurality of attributes of the login events, are received. For example, a threat detection platform receives login event information including indications of login events of a computer account. The received event information can include attributes of the login events such as the IP address, location, and ISP used by a user when attempting to log into a computer account. Other attribute information can include information related to MFA devices and/or access tokens. The attribute information may also include the age and/or frequency associated with event attributes such as the frequency a particular IP address, city, state, country, location, subnetwork and/or another networking address, MFA device, or access/authorization token is used for accessing an account. For example, attributes can be tracked using age and/or frequency metrics. In some embodiments, a subnetwork attribute can correspond to a network portion and/or a host portion and be expressed using a subnet mask, using CIDR notation, and/or using another notation.

In some embodiments, correlations between the plurality of attributes of the login events are tracked. For example, each attribute by itself along with correlations of multiple attributes can be tracked. The correlations of attributes can include combinations of two or more attributes such as <IP address, MFA device>, <IP address, country, MFA device>, and <ISP, subnetwork, access token>, among others. In some embodiments, a new indication of a new login event is received. For example, when a new login event occurs, the threat detection platform receives an indication of the login event. As part of the received indication of the event, the threat detection platform receives event attributes associated with the event, such as the IP address, location, and MFA device used. In some embodiments, based at least in part on the tracked correlations and attributes of the new login event, a machine learning model is used to determine a result associated with whether the new login event is anomalous. For example, a model trained to predict anomalous events is used to predict whether the new login event is anomalous. In some embodiments, the model uses as input event attributes associated with the new event and may take as input correlations of two or more input event attributes.

In some embodiments, a computer security action based on the result of the machine learning model is performed. For example, in the event a login event is predicted as anomalous, a computer security action is performed to minimize the damage of the event. The login event can be blocked, the user account can be suspended, the user account can be required to set up new login credentials such as a new password and/or new MFA device, an existing MFA device can be revoked, an access token such as an Open Authentication (OAuth) token can be revoked, access to resources such as network resources can be restricted, and/or existing user sessions can be invalidated requiring the user to reauthenticate to gain access, among other security actions. Other actions can be performed as well, such as actions on services or applications related to the user login event. For example, additional services monitored by the threat detection platform for the same user can be acted on to minimize damage across other services. Similarly, actions can be performed on groups associated with the user login event, such as groups based on the user locations, user ISP, user subnetwork, the user's organization, etc.

Email account compromise represents one type of business email compromise (BEC) scam. Traditionally, enterprises have protected themselves against BEC scams by employing various defenses, such as anti-spam filters that quarantine malicious emails, intrusion detection rules that flag emails with extensions similar to the domain of the enterprise (e.g., an authentic email whose domain is ABC_Company.com could flag a fraudulent email whose domain is ABC-Company.com), and color coding schemes that cause internal emails to be shown in one color while external emails are shown in another color. But these approaches are largely ineffective in discovering instances of email account compromise since the attacks originate from within the enterprise. This is problematic due to the significant threat that email account compromise represents.

Introduced here, therefore, are threat detection platforms designed to discover possible instances of email account compromise in order to identify threats to an enterprise. In particular, a threat detection platform can examine the digital activities performed with the email accounts associated with employees of the enterprise to determine whether any email accounts are exhibiting abnormal behavior. Examples of digital activities include the reception of an incoming email, transmission of an outgoing email, creation of a mail filter, occurrence of a sign-in event (also referred to as a “login event”), and identification of an identity risk event (e.g., as determined by Microsoft Office® 365). Thus, the threat detection platform can monitor the digital activities performed with a given email account to determine the likelihood that the given email account has been compromised.

Generally, an email account will be identified as possibly compromised if the threat detection platform discovers that the email account either (i) performed at least one digital activity that deviated from past behavior in a meaningful way or (ii) performed at least one digital activity that increased the risk to the security of the enterprise. Examples of digital activities that increase the risk to the security of the enterprise include the transmission of a fraudulent invoice via internal email and the transmission of a phishing attack via internal email. The term “internal email” refers to emails sent within an enterprise (e.g., from an email account associated with one employee to an email account associated with another employee). Generally, internals emails are delivered via an enterprise mail system (also referred to as a “corporate mail system”) without traversing the Internet. The term “external email,” meanwhile, may refer to emails that are received from, or transmitted to, addresses external to the enterprise. While embodiments may be discussed in the context of determining whether email accounts associated with employees of an enterprise are compromised, those skilled in the art will recognize that the features are similarly applicable to other individuals. For example, the threat detection platform could be deployed to examine email transmitted and/or received by a personal email account created through Gmail, Yahoo!Mail, iCloud Mail, etc.

As further discussed herein, the threat detection platform may build a separate model for each email account associated with an enterprise that is representative of the normal behavior of the corresponding employee. The threat detection platform can compare the digital activities performed with each email account to the corresponding model to see whether any deviations exist. Deviations may be indicative of potential compromise since it means the behavior of the email account has changed. By establishing what constitutes normal behavior on a per-employee basis, the threat detection platform can discover and address instances of email account compromise before the enterprise is harmed.

Moreover, the threat detection platform may leverage machine learning, heuristics, rules, and/or human-in-the-loop feedback to improve its ability to discover instances of email account compromise. For example, the threat detection platform may employ a series of rules that separately examine attributes of emails generated by an email account, such as the geographical origin, sender identity, sender email address, recipient identity, recipient email address, subject, body, attachments, etc. Based on these attributes, the series of rules may indicate whether the email account should be examined further due to suspected compromise.

If the threat detection platform determines that an email account may be compromised, the threat detection platform may automatically determine which remediation actions, if any, are appropriate. The remediation actions may depend on the confidence level of the threat detection platform in its determination, the types of digital activities that prompted suspicion, or the threat posed by the compromise. For example, if the threat detection platform determines there is a low likelihood that the email account has been compromised, then the threat detection platform may simply identify the email account as needing further monitoring. However, if the threat detection platform determines there is a high likelihood that the email account has been compromised, then the threat detection platform may restrict access to an enterprise network or prevent further digital activities from being performed. For instance, the threat detection platform could temporarily divert emails generated by the email account into a quarantine inbox until further analysis can occur. Alternatively, the threat detection platform may terminate all active sessions of the email account and prompt the true owner to reset her password. As further discussed below, the likelihood that the email account has been compromised may be determined based on the volume, nature, or type of digital activities performed with the email account under examination.

Perpetrators of email account compromise may employ several different approaches. These approaches include:
Reimbursement schemes in which the attacker requests funds for payment;
Fraud schemes in which the attacker poses as, for example, an executive to request sensitive information or funds; and
Theft schemes in which sensitive information, such as financial information or personal information, is exfiltrated (e.g., by downloading such information from an enterprise network, or by requesting such information from employees in the finance department or human resources department).

While embodiments may be described in the context of a certain approach, those skilled in the art will recognize that the features described herein may be employed to inhibit the impact of email account compromise as a whole. Moreover, embodiments may be described in the context of a certain type of digital activity (e.g., the transmission of an outgoing email) for the purpose of illustration. However, those skilled in the art will recognize that the features described herein are equally applicable to other types of digital activities.

The technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program an electronic device to perform a process for obtaining data related to the digital activities of an email account, examining the data to identify a series of events representative of potential threats to the security of an enterprise, producing a score for each event that corresponds to deviation from past digital activities of the email account, and then determining, based on the scored events, a likelihood that the email account is compromised.

The disclosed techniques provide security threat detection using independent abnormality analysis and risk analysis. In various embodiments, data is ingested and processed to determine insights on whether there is an attack or other type of security threat or event. Upon receiving data from various platforms, the data is standardized into one or more common formats. The data is then enriched with various additional information such as user-level data, network data, behavioral aggregates, or internal/external threat intelligence data. An enriched event may be analyzed to determine a risk score and/or anomaly score. The initial analysis may be based on the event alone. If the risk score and/or anomaly score is above a threshold, secondary analysis may be performed.

The disclosed techniques provide cross-platform security threat detection. The secondary analysis may include using machine learning to identify potential security threats. Unlike the initial single-event analysis, the secondary analysis includes multi-event analysis, which involves multiple events obtained from one or more platforms. For example, the secondary analysis described herein includes identifying a group of cross-platform related events, detecting a potential security threat based on the group, and displaying the result on a user interface.

As further described herein, a security threat detection platform may ingest data from various platforms and then apply, to the data, rules, heuristics, or models that are designed to determine whether events represented in the data are unusual. In some instances, a singular event may be sufficiently unusual so as to be flagged as evidence of a threat. Consider, for example, a scenario where a sign-in activity for an account occurs in a country in which the employee is known or presumed to not be located. In other instances, multiple events—each of which are slightly or mildly unusual—are sufficiently unusual when viewed together so as to be flagged as evidence of a threat.

Surfacing these “multi-event behavioral indicators” is not a trivial task, as the threat detection platform not only has to separately gauge the risk of each event but also collectively gauge the risk of the multiple events in combination—even if those events occur across different platforms. By documenting unusual events occurring across different services in a temporal manner, the threat detection platform can generate an abnormal behavioral case timeline (also called the “abnormal behavior case timeline” or simply “ABC timeline”). At a high level, the ABC timeline is representative of a multi-event “snapshot” of behavior that allows attacks to be more easily detected.

Together, multiple unusual events in the ABC timeline may define a “case” that exhibits characteristics of an attack. Generally, the core components include (i) a primary entity, (ii) a series of notable events, and (iii) a judgment (and in some embodiments, a prediction of attack type and/or a prediction of attack severity). Generally, the primary entity is either a person or document, depending on the type of event (and therefore, the nature of the platform from which the data representing the event is acquired). However, the primary entity could be another type of object or even a piece of information. For example, if an event is representative of a transmission or receipt of a communication, then the primary entity may be the person that is associated with the account that transmitted or received the communication. As another example, if an event is representative of a sign-in activity for a platform through which information is accessed, then the primary entity may be the information. Meanwhile, the series of notable events may include any events involving the primary entity that have been determined to be unusual. Events that have been deemed normal may be discarded by the threat detection platform, and therefore not recorded in the ABC timeline.

The ABC timeline allows the threat detection platform to use its core infrastructure across different use cases (e.g., from business email compromise to internal phishing to account takeover), across different platforms (e.g., from communication platforms to non-communication platforms), etc.

In various embodiments, insight into security posture is handled by a threat detection platform by integrating security posture management with the inbound email security platform to provide deep insight into changes across people, vendors, applications, and tenants. Information included in Knowledge Bases, such as event streams detailing occurrences and changes across applications such as via AppBase, mail tenants such as mail tenants in TenantBase, and internal and external users with services such as PeopleBase, may be used. The threat detection platform and associated security posture management distill email platform event data into posture-specific configuration changes and can provide real-time insight to administrators. These changes can be quickly acknowledged through an automated workflow so teams can stay aware of changes and mitigate risks when necessary.

In the event a phishing campaign is successful, attackers can obtain login credentials for an account and then register their own device as a “trusted device” with an email provider. This allows the attacker to circumvent requirements for MFA and bypass security filters. An approach to detecting and blocking this malicious activity is to identify if a newly added “trusted device” indeed belongs to the purported legitimate user. Using techniques described herein, it can be detected when a new device is registered as “trusted.” Additional signals such as locations for where login and MFA authentication is happening now vs. the established behavior for the user can be examined. The additional context allows malicious activity to be detected. Logs of activity happening within an account can be downloaded from a service provider's API. When a new device is registered with an account, an event is triggered by the service provider. An email notification of the activity can be sent to the registered user but attackers can hide such email. Since the events are downloaded directly from the API, a security platform can be alerted in real-time. In various embodiments, machine learning models used for detection of malicious activity can utilize a feature that captures “age of device.” This input feature can become active when a new device is added. For example, for the new device adding event, a comparison can be made of the signals observed from the new device to those typically observed for older devices registered with the account. These signals include but are not limited to: IP, location, ISP, etc. Examples of location data include city, state, country, region, and geographic coordinate information, among other location information. In addition to IP and ISP information, other networking information can further include a user's network address, sub-address, or subnetwork. Similarly, access techniques such as MFA and access tokens are additional input signals. Moreover, for each signal, corresponding signals can include the associated age and/or frequency of the signal or related event data. For example, input signals can include metric attributes associated with the age and/or frequency of a location, MFA device, access token, and/or another input signal. In various embodiments, the input signal and combinations or correlations of input signals are used to differentiate anomalous behavior from normalized behavior.

In some embodiments, a distributed hash map or similar data structure can be used to track statistics on how frequently certain attributes are seen. Sets of attributes (e.g., IPs/locations) can be considered as suspicious due to high volumes of attacks containing them. Using a distributed hash map or similar data structure, input signals and their correlations including variations based on different windows of time can be tracked. For example, a distributed hash map can be used to track the correlated values of two input signals for periods or intervals of time corresponding to the last 7 days, 20 days, 30 days, 1 month, 3 months, 6 months, and/or 12 months.

As mentioned above, one technique attackers use to circumvent account take over detection is to mimic legitimate applications to trick the legitimate user into giving an access token, such as an OAuth grant, to a malicious application. The granted token can be used for machine-to-machine communication and therefore does not require MFA. In various embodiments, the threat detection platform can implement an approach to detect this attack by monitoring event activity. For example, an activity audit log can be ingested and examined which covers which users gave consent to which applications. The log data can be run through a behavioral detection engine. When new devices are registered as “trusted,” information such as where logins originate and MFA authentication is happening can be used to detect attacks. Of note, detection can be made even if the attacker manages to register their own devices as “trusted” with identity providers.

The following is an example of event data (raw anonymized signin event content received from O365):

```
{
    ″id″: ″88e0e3b6-cb55-4d97-80ec-9c58ad4d6300″,
    ″createdDateTime″: ″2019-04-29T13:37:36.8986143Z″,
    ″userDisplayName″: ″John Siam″,
    ″userPrincipalName″: ″john.siam@example.com″,
    ″userId″: ″10e3bcc2-a058-4680-85ca-b9233b7596a7″,
    ″appId″: ″103a3b87-a06d-4817-b275-7a316988d93b″,
    ″appDisplayName″: ″Windows Sign In″,
    ″ipAddress″: ″123.4.38.250″,
    ″clientAppUsed″: ″Mobile Apps and Desktop clients″,
    ″userAgent″: ″Mozilla/5.0 (Macintosh; Intel Mac OS X 10_14_6)
    AppleWebKit/537.36 (KHTML, like Gecko) Chrome/87.0.4280.88
    Safari/537.36″,
    ″correlationId″: ″109a5a29-353e-4f25-b070-4a904d922b2a″,
    ″conditionalAccessStatus″: ″success″,
    ″originalRequestId″: None,
    ″isInteractive″: True,
    ″tokenIssuerName″: None,
    ″authenticationrequirement″: ″multiFactorAuthentication″,
    ″tokenIssuerType″: ″AzureAD″,
    ″processingTimeInMilliseconds″: 0,
    ″riskDetail″: ″none″,
    ″riskLevelAggregated″: ″none″,
    ″riskLevelDuringSignIn″: ″none″,
    ″riskState″: ″none″,
    ″riskEventTypes″: [ ],
    ″resourceDisplayName″: ″windows azure active directory″,
    ″resourceId″: ″00000002-0000-0000-c000-000000000000″,
    ″authenticationMethodsUsed″: [ ],
    ″status″: {
      ″errorCode″: 0,
      ″failureReason″: None,
      ″additionalDetails″: ″MFA requirement satisfied by claim in the
    token″,
    },
    ″deviceDetail″: {
      ″deviceId″: ″10d62882-c49e-423a-bfb9-5086f54ca0be″,
      ″displayName″: ″NY-11041″,
      ″operatingSystem″: ″Windows 10″,
      ″browser″: ″Chrome 99.0.4844″,
      ″isCompliant″: True,
      ″isManaged″: True,
      ″trustType″: ″Azure AD registered″,
    },
    ″location″: {
      ″city″: ″Billingdon″,
      ″state″: ″Greater Glasgow″,
      ″countryOrRegion″: ″GB″,
      ″geoCoordinates″: {
        ″altitude″: None,
        ″latitude″: 10.52471923828125,
        ″longitude″: −0.4422200083732605,
      },
    },
    ″mfaDetail″: {″authMethod″: None, ″authDetail″: None},
    ″appliedConditionalAccessPolicies″: [ ],
    ″authenticationProcessingDetails″: [ ],
    ″authenticationDetails″: [
    {
      ″authenticationStepDatetime″: ″2020-08-27T00:05:53.9010677Z″,
      ″authenticationMethod″: ″Mobile app notification″,
      ″authenticationMethodDetail″: ″+X XXXXXXXX20″,
      ″succeeded″: True,
      ″authenticationStepResultDetail″: ″MFA completed in Azure AD″,
      ″authenticationStepRequirement″: ″MultiConditionalAccess″,
    }
    ],
    ″networkLocationDetails″: [ ],
  }
```

The above example event data includes input signals corresponding to location, networking, MFA, and access token information, among other input data. For example, the location information includes information corresponding to city, state, country, region, and geographical coordinates. By learning the normal access behavior from ingested event data, the disclosed threat detection platform can predict events that are anomalous and perform the appropriate computer security actions.

The following are examples of features that can be used in a detector that intentionally targets the above decision scenario. The signals can be used for model training and detection improvements:
SIGNIN_EVENT_STATUS
SIGNIN_EVENT_FAILED
SIGNIN_EVENT_FAILED_AT_MFA
SIGNIN_EVENT_FAILED_MALICIOUS_IP_FROM_SOURCE_API
SIGNIN_EVENT_FAILURE_TRIGGER
SIGNIN_EVENT_MFA_STATE
SIGNIN_EVENT_EMAIL_SOURCE
SIGNIN_EVENT_AUTHENTICATION_REQUIREMENT
SIGNIN_EVENT_AUTHENTICATION_METHOD
SIGNIN_EVENT_MFA_SATISFY_REASON
SIGNIN_EVENT_MFA_SKIP_REASON
SIGNIN_EVENT_MFA_DENY_REASON
DEVICE_COMPLIANCE
DEVICE_TRUST_TYPE
DEVICE_IS_MANAGED
SUCCESSFUL_MFA_FROM_SAME_IP
SUCCESSFUL_MFA_FROM_SAME_CITY
SUCCESSFUL_MFA_FROM_SAME_STATE_OR_COUNTRY
HAS_SUCCESSFUL_SECOND_FACTOR_AUTHENTICATION
FAILED_MFA_COUNT
MAX_IP_FREQUENCY_FOR_USER
MAX_CIDR_24_FREQUENCY_FOR_USER
MAX_CITY_FREQUENCY_FOR_USER
MAX_STATE_FREQUENCY_FOR_USER
MAX_COUNTRY_FREQUENCY_FOR_USER
NEW_DEVICE_NOTIFICATION
OAUTH_GRANT_APPLICATION_NAME
OAUTH_GRANT_APPLICATION_AGE
OAUTH_GRANT_APPLICATION_PUBLISHER_NAME
OAUTH_GRANT_APPLICATION_PUBLISHER_AGE
OAUTH_GRANT_APPLICATION_SCOPE
OAUTH_GRANT_PUBLISHER_URL
DEVICE_REGISTRATION_AGE

The above example feature data includes age and frequence information for input signals, such as the age associated with a device registration and the frequency associated with a MFA device, IP address, network address, location, and access token. For example, the location frequency information includes frequency information corresponding to city, state, and country signals. By learning the normal access behavior from ingested event data, the disclosed threat detection platform can predict events that are anomalous and perform the appropriate computer security actions.

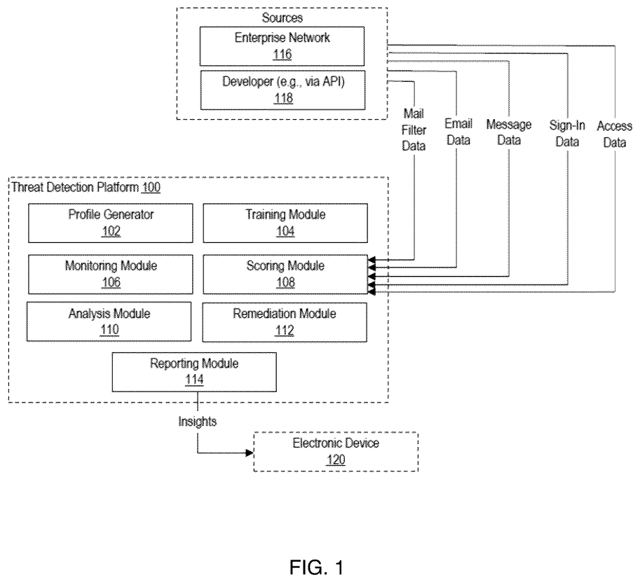

FIG. 1 is a block diagram illustrating an embodiment of a system for security threat detection. In various embodiments, this system is a threat detection platform that examines the digital conduct of accounts associated with employees to detect threats to the security of an enterprise. The detected threats to a network, such as a customer network, corporate network, or enterprise network, can include threats posed by compromised accounts including email accounts belonging to users such as employees. As shown here, the threat detection platform 100 may include a profile generator 102, a training module 104, a monitoring module 106, a scoring module 108, an analysis module 110, a remediation module 112, and a reporting module 114. Some embodiments of the threat detection platform 100 include a subset of these components, while other embodiments of the threat detection platform 100 include additional components that are not shown in FIG. 1.

At a high level, the threat detection platform 100 can acquire data related to digital conduct and activities of accounts associated with employees and then determine, based on an analysis of the data, how to handle security threats in a targeted manner. The security threats can include compromised accounts including email accounts. Thus, threat detection platform 100 can detect possible instances of email account compromise based on data such as emails (e.g., the content of the body or attachments), email metadata (e.g., information regarding the sender, recipient, origin, time of transmission, etc.), sign-in metadata (e.g., information regarding the time and location of each sign-in event), and other suitable data. Some data may be acquired from an enterprise network 116, while other data may be acquired from a developer 118 of a platform, for example, via an application programming interface (“API”). As shown in FIG. 1, the data may include information related to emails, messages, mail filters, sign-in activities, access activities, and the like. As further discussed below, these data are not necessarily obtained from the same source. As an example, data related to emails may be acquired from an email service (e.g., Microsoft Exchange™) while data related to messages may be acquired from a messaging service (e.g., Slack®).

The threat detection platform 100 can be implemented, partially or entirely, within an enterprise network 116, a remote computing environment (e.g., through which the data regarding digital conduct is routed for analysis), a gateway, or another suitable location. The remote computing environment can belong to, or be managed by, the enterprise or another entity. In some embodiments, the threat detection platform 100 is integrated into the enterprise's email system (e.g., at the gateway) as part of an inline deployment. In other embodiments, the threat detection platform 100 is integrated into the enterprise's email system via an API such as the Microsoft Outlook® API. In such embodiments, the threat detection platform 100 may obtain data via the API. Thus, the threat detection platform 100 can supplement and/or supplant other security products employed by the enterprise.

In a first variation, the threat detection platform 100 is maintained by a threat service (also referred to as a “security service”) that has access to multiple enterprises' data. In this variation, the threat detection platform 100 can route data that is, for example, related to incoming emails to a computing environment managed by the security service. The computing environment may be an instance on Amazon Web Services®. The threat detection platform 100 may maintain one or more databases for each enterprise that include, for example, organizational charts, attribute baselines, communication patterns, and the like. Additionally or alternatively, the threat detection platform 100 may maintain federated databases that are shared amongst multiple entities. Examples of federated databases include databases specifying vendors and/or individuals who have been deemed fraudulent, domains from which incoming emails determined to be malicious originated, and the like. The security service may maintain different instances of the threat detection platform 100 for different enterprises, or the security service may maintain a single instance of the threat detection platform 100 for multiple enterprises. The data hosted in these instances can be obfuscated, encrypted, hashed, depersonalized (e.g., by removing personal identifying information), or otherwise secured or secreted. Accordingly, each instance of the threat detection platform 100 may only be able to access and then process data related to the accounts associated with the corresponding enterprise(s).

In a second variation, the threat detection platform 100 is maintained by the enterprise whose accounts are being monitored—either remotely or on premises. In this variation, all relevant data may be hosted by the enterprise itself, and any information to be shared across multiple enterprises can be transmitted to a computing system that is maintained by the security service or a third party.

As shown in FIG. 1, the profile generator 102, training module 104, monitoring module 106, scoring module 108, analysis module 110, remediation module 112, and reporting module 114 can be integral parts of the threat detection platform 100. Alternatively, these components could be implemented individually while operating “alongside” the threat detection platform 100. For example, the reporting module 114 may be implemented in a remote computing environment to which the threat detection platform 100 is communicatively connected across a network. As mentioned above, the threat detection platform 100 may be implemented by a security service on behalf of an enterprise or the enterprise itself. In some embodiments, aspects of the threat detection platform 100 are accessible or interactable via a web-accessible computer program operating on a computer server or a distributed computing system. For example, an individual may be able to interface with the threat detection platform 100 through a web browser that is executing on an electronic computing device (also called an “electronic device” or “computing device”).

The enterprise network 116 may be a mobile network, wired network, wireless network, or some other communication network maintained by the enterprise or an operator on behalf of the enterprise. As noted above, the enterprise may utilize a security service to examine events to discover potential security threats including instances of account compromise (such as email account compromise). For example, the enterprise may grant permission to the security service to monitor the enterprise network 116 by examining emails (e.g., incoming emails or outgoing emails) and then addressing those emails that represent security threats. In some embodiments, the security service analyzes emails to discover possible instances of email account compromise and performs some remediation action if a threat is discovered. The threat detection platform 100 may be permitted to remediate the threats posed by those emails, or the threat detection platform 100 may be permitted to surface notifications regarding the threats posed by those emails. In some embodiments, the enterprise further grants permission to the security service to obtain data regarding other digital activities involving the enterprise (and, more specifically, employees of the enterprise) in order to build a profile that specifies communication patterns, behavioral traits, normal context of emails, normal content of emails, etc. For example, the threat detection platform 100 may identify the filters that have been created and/or destroyed by each employee to infer whether any significant variations in behavior have occurred. As another example, the threat detection platform 100 may examine the emails or messages received by a given employee to establish the characteristics of normal communications (and thus be able to identify abnormal communications). As another example, the threat detection platform 100 may examine sign-in activities to establish characteristics (e.g., in terms of location, time, frequency) that can then be used to establish whether a single sign-in activity is unusual or a combination of sign-in activities is unusual.

The threat detection platform 100 may manage one or more databases in which data can be stored. Examples of such data include enterprise data (e.g., email data, message data, sign-in data, access data, and mail filter data), threat analysis data, remediation policies, communication patterns, behavioral traits, and the like. The data stored in the database(s) may be determined by the threat detection platform 100 (e.g., learned from data available on the enterprise network 116 or available from the developer 118), provided by the enterprise, or retrieved from an external database (e.g., associated with LinkedIn®, Microsoft Office 365®, or Google Workspace™). The threat detection platform 100 may also store outputs produced by the various modules, including machine- and human-readable information regarding insights into threats and any remediation actions that were taken.

In various embodiments, by examining obtained data, such as the email data, mail filter data, and sign-in data, the threat detection platform 100 can discover organizational information (e.g., the employees, titles, and hierarchy), employee behavioral traits (e.g., based on historical emails and historical sign-in events), normal email content, normal email addresses, communication patterns (e.g., who each employee communicates with internally and externally, when each employee typically communicates), etc.

As shown in FIG. 1, the threat detection platform 100 may include a profile generator 102 that is responsible for generating one or more profiles for the enterprise. For example, the profile generator 102 may generate a separate profile for each account associated with an employee of the enterprise based on the sign-in data, message data, email data, or mail filter data. Additionally or alternatively, profiles may be generated for business groups, organizational groups, or the enterprise as a whole. Examining the data may enable the profile generator 102 to discover organizational information (e.g., employees, titles, and hierarchy), employee behavioral traits (e.g., based on historical emails, messages, and historical mail filters), normal content of incoming or outgoing emails, behavioral patterns (e.g., when each employee normally logs in), communication patterns (e.g., who each employee communicates with internally and externally, when each employee normally communicates), etc. This information can be populated into the profiles so that each profile can be used as a baseline for what constitutes normal activity by the corresponding account (or group of accounts).

In some embodiments, a profile may include primary attributes, secondary attributes, or other suitable features. These attributes may be represented as median values, mean values, standard deviations, ranges, or thresholds. Moreover, the profile may include a series of values in a temporal order so that deviations (e.g., in the time of sign-in events, or in the other employees to which outgoing emails are addressed) can be more easily detected.

Primary attributes are preferably features extracted directly from a communication or an event by an extraction module (also referred to as an “extractor”). The term “extractor,” as used herein, may be used to refer to a piece of software programmed to extract a given type of information from underlying data. Generally, each primary attribute is extracted by a separate primary extractor. Primary extractors can be global (e.g., shared across multiple enterprises) or specific to an enterprise. Examples of primary attributes include the sender display name, sender username, recipient display name, recipient username, Sender Policy Framework (SPF) status, DomainKeys Identified Mail (DKIM) status, number of attachments, number of links in the body, spam/phishing metrics (e.g., continent or country of origin), whether data between two fields that should match are mismatched, and header information. Primary attributes could also be derived from metadata associated with a communication. Examples of such primary attributes include an enterprise identifier, message identifier, conversation identifier, sender identifier, time of transmission/receipt, etc.

Secondary attributes are generally attributes that are determined from the primary attributes and/or other data (e.g., as determined from threat detection datastore). For example, the secondary attributes may be extracted, inferred, or calculated from the primary attributes. The secondary attributes may be determined by one or more secondary extractors. Secondary extractors can be global (e.g., shared across multiple enterprises) or specific to an enterprise. The secondary attributes can be determined from a temporal series of primary attribute values (e.g., where each primary attribute value is associated with a timestamp, such as the sent timestamp or receipt timestamp), from a single primary attribute value, or from the values of multiple primary attributes. Examples of secondary attributes include frequencies, such as sender frequencies (e.g., sender fully qualified domain name (FQDN) frequencies, sender email frequencies, etc.), recipient frequencies (e.g., recipient FQDN frequencies, recipient email frequencies, etc.), and domain frequencies (e.g., SPF status frequencies for a given domain, DKIM status frequencies for a given domain, the frequency with which the enterprise receives comparable emails from a given domain, the number/frequency of emails received from a given domain, the number/frequency of emails transmitted to a given domain, etc.); mismatches between primary attributes that should match; employee attributes (e.g., name, title, employment status, attack history, etc.); whether the body of an outgoing/incoming email includes high-risk words, phrases, or sentiments (e.g., whether the body includes financial vocabulary, credential theft vocabulary, engagement vocabulary, non-ASCII content, attachments, links, etc.); domain information (e.g., domain age, whether the domain is blacklisted or whitelisted; whether the domain is internal or external, etc.); heuristics (e.g., whether an attachment or link has been seen before in communications from a given email account, whether a given email account has previously communicated during a given timeframe, from a given location, etc.); and notable deviations (e.g., in the frequency, content, or location of activities performed with a given email account). As noted above, the secondary attributes may be determined as a function of the primary attributes. An example of a primary attribute is an email address associated with an email account belonging to an employee of an enterprise, while an example of a secondary attribute is statistics regarding the pattern of digital activities (e.g., sign-in events) performed with the email account.

A profile could include a number of behavioral traits associated with the corresponding account. The profile generator 102 may determine the behavioral traits based on the access data, sign-in data, message data, email data, mail filter data, and any other data that is obtained from the enterprise network 116, developer 118, or another source. In some embodiments, the email data may include information on the recipients of past emails sent by a given email account, content of the past emails, frequency of the past emails, temporal patterns of the past emails, formatting characteristics (e.g., usage of HTML, fonts, styles, etc.), sensitive topics on which the corresponding employee is explicitly or implicitly authorized to communicate, geographical location from which the past emails originated, and more. In some embodiments, the email data may include information on the senders of past emails received by a given email account, content of those past emails, frequency of those past emails, temporal patterns of those past emails, topics of those past emails, geographical locations from which those past emails originated, formatting characteristics (e.g., usage of HTML, fonts, styles, etc.), and more. For the given email account, the profile generator 102 may attempt to build a profile that includes information regarding the other email accounts to which emails are commonly transmitted to or received from, normal content of incoming and outgoing emails, normal transmission times, normal transmission locations, and the like. Accordingly, the profile generator 102 may attempt to build a profile for each account that represents a model of normal behavior of the corresponding employee. As further discussed below, the profiles may be helpful in identifying digital activities (also called “events”) that are unusual, and therefore may be indicative of a security threat.

In various embodiments, examples of questions that a profile may attempt to address for a given email account include: What email addresses does the given email account communicate with? What topics does the given email account normally discuss? What are normal login times for the given email account? What are normal email sending times for the given email account? What Internet Protocol (IP) address(es) does the given email account log in from? What geographical locations does the given email account log in from? Does the given email account have any suspicious mail filters set up (e.g., hackers of compromised email accounts may automatically delete incoming emails containing certain keywords to conceal illicit activity from the true owner)? What tone/style does the given email account use? What signatures (e.g., “cheers” or “thanks”) does the given email account use? When the given email account sends emails with links/attachments, what are the characteristics (e.g., name, extension, type, size) of those attachments?

The monitoring module 106 may be responsible for monitoring communications (e.g., messages and emails) handled by the enterprise network 116. These communications may include incoming emails (e.g., external and internal emails) received by accounts associated with employees of the enterprise, outgoing emails (e.g., external and internal emails) transmitted by those accounts, and messages exchanged between those accounts. In some embodiments, the monitoring module 106 is able to monitor incoming emails in near real time so that appropriate action can be taken if a malicious email is discovered. For example, if an incoming email is determined to be representative of a phishing attack (e.g., based on an output produced by the scoring module 108), the incoming email may be prevented from reaching its intended destination by the monitoring module 106 at least temporarily. In various embodiments, if the monitoring module 106 discovers that outgoing emails generated by an email account indicate that the email account may have been compromised, the remediation module 112 may temporarily prevent all outgoing emails transmitted by the email account from reaching their intended destination. In some embodiments, the monitoring module 106 is able to monitor communications only upon the threat detection platform 100 being granted permission by the enterprise (and thus given access to the enterprise network 116 or another source).

The scoring module 108 may be responsible for examining digital activities to determine the likelihood that a security threat exists. For example, the scoring module 108 may examine each incoming email to determine how its characteristics compare to past emails sent by the sender or received by the recipient. In such a scenario, the scoring module 108 may determine whether characteristics such as timing, formatting, and location of origination (e.g., in terms of sender email address or geographical location) match a pattern of past emails that have been determined to be non-malicious. For example, the scoring module 108 may determine that an email is likely malicious if the sender email address (support-xyz@gmail.com) differs from an email address (John.Doe@CompanyABC.com) that is known to be associated with the alleged sender (John Doe). As another example, the scoring module 108 may determine that an account may be compromised if the account performs a sign-in activity that is impossible or improbable given its most recent sign-in activity. As another example, the scoring module 108 may determine that an account may be compromised if the account performs an access event that is impossible or improbable given its most recent access event.

The scoring module 108 can make use of heuristics, rules, neural networks, or other trained machine learning (“ML”) algorithms that rely on decision trees (e.g., gradient-boosted decision trees), logistic regression, or linear regression. Accordingly, the scoring module 108 may produce discrete outputs or continuous outputs, such as a probability metric (e.g., specifying the likelihood that an incoming email is malicious), a binary output (e.g., malicious or not malicious), or a classification (e.g., specifying the type of malicious email).

As mentioned above, the scoring module 108 may also consider combinations of digital activities—across the same platform or different platforms—to determine whether a security threat exists. This may be done in a “rolling” manner, where each digital activity performed with a given account is compared against prior digital activities performed with the given account that have been identified as unusual to some degree. Moreover, each digital activity performed with the given account could be compared against prior digital activities performed with related accounts (e.g., corresponding to other platforms) that have been identified as unusual to some degree.

The analysis module 110 may be responsible for considering whether different combinations of digital activities are indicative of a security threat. For example, the scoring module may perform functions associated with secondary analyzer 350. For example, the analysis module 110 may determine, based on the scores produced by the scoring module 108, whether a digital activity is individually indicative of a security threat or collectively—with at least one other digital activity—indicative of a security threat. Assume, for example, that the scores produced by the scoring module 108 are representative of deviation values, indicating the degree to which each corresponding digital activity deviates from past digital activities performed on the same platform with that account. These deviation values can be supplied to the analysis module 110, and the analysis module 110 may input these deviation values into a rules-based engine, heuristics-based engine, or model that predicts the likelihood of a security threat.

In some embodiments, the analysis module 110 operates to analyze each digital activity performed with an email account to determine the likelihood that the email account has been compromised. For example, the analysis module 110 may examine each email received and/or transmitted by the email account to determine whether those emails deviate from past email activity. In such embodiments, the analysis module 110 may determine whether a given email deviates from the past email activity (and thus may be indicative of compromise) based on its primary and/or secondary attributes. For example, the analysis module 110 may determine that compromise is likely if an email account logs into the enterprise network 116 in an unusual location (e.g., China) or at an unusual time (e.g., 3 AM) based on a comparison to past sign-in events. As another example, the analysis module 110 may determine that compromise is likely if an email account transmits an email message that deviates from the characteristics of past emails transmitted by that email account (e.g., has no subject line, has a different signature, includes a link with no context in the body, etc.).

The analysis module 110 can make use of heuristics, neural networks, rules, decision trees (e.g., gradient-boosted decision trees), or ML-trained algorithms (e.g., decision trees, logistic regression, linear regression). Accordingly, the analysis module 110 may output discrete outputs or continuous outputs, such as a probability metric (e.g., specifying likelihood of compromise), a binary output (e.g., compromised or not compromised), an attack classification (e.g., specifying the type of scheme employed), etc.

For each email transmitted by an email account, the analysis module 110 may determine whether the email deviates from traits (e.g., behavioral traits or content traits) learned from past emails transmitted by the email account. The deviation may be a numerical value or percentage representing a delta between traits and a corresponding feature extracted from the email. For example, if the trait specifies that emails are transmitted by Joe.Smith@Enterprise.com almost exclusively between 8 AM and 5 PM, then an email transmitted at 3 AM may be assigned a relatively high deviation value. However, if Joe.Smith@Enterprise.com sends emails between 5 PM and 8 AM approximately 20 percent of the time, then the deviation value will be lower than the previous example.

These deviation values can be fed by the analysis module 110 as input into one or more attack detectors, each of which can generate an output. Each attack detector may be a rules-based engine, heuristic engine, or ML model designed to detect possible instances of a given type of attack. For example, these deviation values may be fed into an ML model designed/trained to identify theft schemes. The analysis module 110 may flag the email account as possibly compromised if an indication is received from the attack detector(s) that a deviation threshold has been exceeded.

The remediation module 112 may perform one or more remediation actions in response to the analysis module 110 determining that an account, such as an email account or an account of another service, may be compromised. The remediation action(s) may be based on the nature of the threat, the policies implemented by the enterprise, etc. These policies may be predefined or dynamically generated based on inference, analysis, or the data obtained by the threat detection platform 100 (e.g., from the enterprise network 116 or developer 118). Examples of remediation actions include moving communications generated by a compromised account into a hidden folder (also referred to as a “quarantine folder”) for further analysis, prohibiting a compromised account from accessing sensitive information, sending notifications (e.g., to the actual employee, enterprise, or member of the security service), resetting the password of the compromised account, ending all active sessions of the compromised account, and resetting connections with services/databases accessible via the enterprise network 116.

In some embodiments, the remediation module 112 may provide results produced by the monitoring module 106 or some other output (e.g., a notification that an email account may be compromised) to an electronic device 120. The electronic device 120 may be managed by the employee associated with the email account under examination, an individual associated with the enterprise (e.g., a member of the information technology department), or an individual associated with a security service. In some embodiments, the remediation module 112 sends the output in a human-readable format for display on an interface accessible via the electronic device 120. In some embodiments, one or all of these functions are performed by the reporting module 114.

The reporting module 114 may be responsible for reporting insights derived from the outputs that are produced by the scoring module 108. For example, the reporting module 114 may provide a summary of the threats discovered through analysis of the outputs produced by the scoring module 108 to an electronic device 120. The electronic device 120 may be managed by the employee associated with the account under examination, an individual associated with the enterprise (e.g., a member of the IT department), or an individual associated with a security service. The reporting module 114 can surface insights into threats in a human-readable format for display on an interface accessible via the electronic device 120.

As shown in FIG. 1, the threat detection platform 100 may also include a training module 104 that operates to train the models employed by the other modules such as to train the ML model(s) employed by the analysis module 110. For example, if the analysis module 110 is designed to apply ML model(s) to the email data, mail filter data, or sign-in data obtained from the enterprise network 116 (and/or other sources), the training module 104 can train the ML model(s) by feeding training data into those ML model(s). The training data could include labeled digital activities (e.g., emails that have been labeled as attacks or non-attacks), policies related to primary or secondary attributes (e.g., that sign-in events occurring in a given location are authentic due to the use of a virtual private network (VPN) service), etc. The training data may be employee- or enterprise-specific so that the ML model(s) are able to perform personalized analysis. In some embodiments, the training data ingested by the ML model(s) includes malicious emails that are representative of known instances of email account compromise. For example, these malicious emails may include language known to represent instances of fraud. As another example, these malicious emails may include links to URLs or attachments known to represent instances of phishing.

In some embodiments, the training module 104 may train the models applied by the scoring module 108 to the sign-in data, message data, email data, or mail filter data by feeding training data into those models. The training data could include emails that have been labeled as malicious or non-malicious, policies related to attributes of emails (e.g., specifying that emails originating from certain domains should not be considered malicious), etc. The training data may be employee- or enterprise-specific so that the model(s) are able to perform personalized analysis. In some embodiments, the training data ingested by the model(s) includes emails that are known to be representative of malicious emails sent as part of an attack campaign. These emails may have been labeled as much during a training process, or these emails may have been labeled as much by other employees.

Moreover, the training module 104 may implement a retraining pipeline (or simply “pipeline”) in order to protect against novel threats as further discussed below. At a high level, the pipeline may be representative of a series of steps that, when executed by the training module 104, cause the models employed by the scoring module 108 to be retrained. By consistently training the models using up-to-date information, the threat detection platform 100 can protect against novel threats that would otherwise escape detection.

Some enterprises may wish to receive intelligence about potential instances of email account compromise that have been discovered by the threat detection platform 100. Because the threat intelligence platform can monitor various types of data in real time, unique intelligence can be produced that allows abnormal behavior indicative of email account compromise to be detected more quickly, accurately, and consistently.

As discussed herein, the threat detection platform 100 may be designed to capture compromise signals gleaned from a variety of sources, including external sources and internal sources. Examples of compromise signals include IP addresses, email addresses, URLs, domains, attachments, cryptocurrency addresses, etc. Normally, a separate database of compromise signals is generated for each enterprise due to the targeted nature of malicious emails generated by compromised email accounts. However, a shared database of compromise signals can be useful in several respects. For example, a shared database may be useful to the threat detection platform 100 that has been tasked with monitoring the emails of an enterprise for which a database has not yet been compiled. A shared database may also be helpful in building a better understanding of the threats posed to enterprises since most enterprises experience relatively few instances of email account compromise (e.g., a large enterprise of several thousand employees may discover a couple of instances of email account compromise per year).

Moreover, the database could be provided to enterprises for ingestion into other security products, such as firewalls and security orchestration, automation, and response (SOAR) tools. For example, an enterprise may find it useful to provide compromise signals deemed to correspond to increased security risk to a management tool, such as a gateway, to help protect employees from future threats, poor choices, etc. As another example, an enterprise may identify email accounts associated with compromise signals for further examination.

As discussed herein, the threat detection platform 100 may be programmed to infer the threat posed by each compromise signal. For example, the threat detection platform 100 might classify each compromise signal as being representative of low, moderate, or high risk to the security of the enterprise. Additionally or alternatively, the threat detection platform 100 might classify each compromise signal as being representative of a reimbursement scheme, fraud scheme, or theft scheme.

Many enterprises may find it sufficient to examine compromised email accounts that have been surfaced by the threat detection platform 100. However, some enterprises have begun monitoring compromise signals in order to better address threats in real time. For instance, an enterprise may monitor compromise signals gleaned from internal emails by the threat detection platform 100 to identify appropriate remediation actions, preventive measures, etc.

In various embodiments, at a high level, the threat detection platform 100 can be designed to:
Ingest intelligence from different sources such as:
   Compromise signals derived from digital activities (e.g., links to malicious URLs embedded in internal emails);
   Inferred compromise signals based on statistics of past attacks (e.g., the number of malicious emails generated by a given email account);
   Threat information surfaced by other security products deployed by enterprises; and
   Security professionals employed by enterprises; and
Export intelligence, for example, as a database to be used while examining digital activities or a feed to be ingested by other security products.

In some embodiments, the threat detection platform 100 may be designed to address compromise signals on a per-enterprise or per-employee basis. For example, the threat detection platform 100 could maintain a first list of compromise signals that should not be observed in any internal emails and a second list of compromise signals that should only be observed in a subset of internal emails (e.g., those addressed to, or sent by, the finance department). As another example, the threat detection platform 100 could maintain a list of compromise signals (e.g., specifying certain geographical locations) that should not be observed in any sign-in events. In some embodiments, the threat detection platform 100 is able to place limits on each compromise signal to prevent permanent blacklisting. For example, the threat detection platform 100 may discover an internal email that includes a link to a website that hosts a phishing page. In such a scenario, the threat detection platform 100 may capture the website (and, more specifically, its URL) as a compromise signal for a specified period of time after which the threat detection platform 100 can check whether the website is still hosting the phishing page.

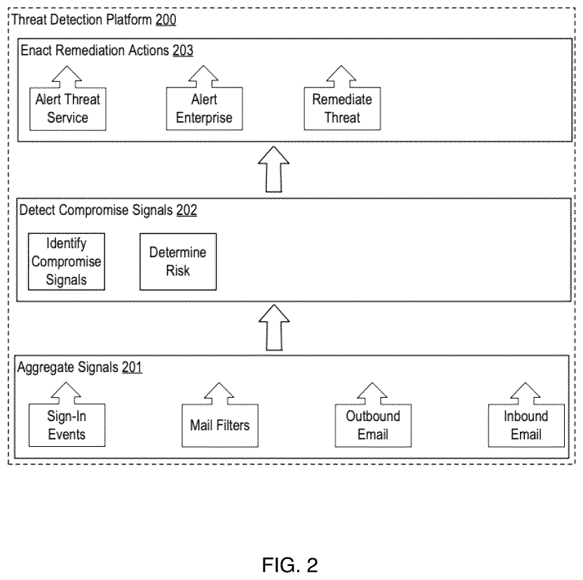

FIG. 2 is a diagram illustrating an embodiment of a multi-tiered approach for information aggregation. As shown in FIG. 2, the threat detection platform 200 can employ a multi-tiered approach to aggregate information (also referred to as “signals”) related to the employees of an enterprise (step 201), examine the signals to discover compromise signals that may be indicative of email account compromise (step 202), and then enact remediation actions (step 203) to address the threat to an enterprise. In some embodiments, the threat detection platform 200 is the threat detection platform 100 of FIG. 1.

Unlike conventional filtering services, the threat detection platform 200 can be completely integrated within the enterprise environment. For example, the threat detection platform may receive input indicative of an approval by an individual (e.g., an administrator associated with the enterprise) to access data related to the digital activities performed with email accounts associated with employees of the enterprise. The data may include, for example, information on emails (e.g., incoming emails and outgoing emails), mail filters, mail groups, sign-in events, identity risk events, active directory, accessed documents, etc. The approval may be given through an interface generated by the threat detection platform 200. For example, the individual may access an interface generated by the threat detection platform 200 and then approve access to the data as part of a registration process.

Then, the threat detection platform 200 can establish a connection with one or more storage mediums that include the data via corresponding application programming interfaces (APIs). For example, the threat detection platform 200 may establish, via an API, a connection with a computer server managed by the enterprise or some other entity on behalf of the enterprise. The threat detection platform 200 can download the data from the storage medium(s) in a programming environment managed by the threat detection platform 200. For instance, the threat detection platform 200 may obtain information regarding the outgoing emails, incoming emails, mail filters, and sign-in events associated with each email account managed by the enterprise. As further discussed below, the threat detection platform 200 may process the information in order to define a series of digital activities performed with each email account over time. The information that defines each digital activity may be referred to as a “signal.”

Accordingly, the threat detection platform 200 may be designed to obtain and/or monitor data in at least one datastore via an API, aggregate the data in these datastores, and then canonicalize the data into a single event stream in order to perform behavioral analysis (e.g., by detecting behavioral deviations). Such an approach ensures that the data in these various datastores can be holistically monitored to gain a better understanding of behavioral patterns on a per account, per-employee, or per-enterprise basis. Since the data can be accessed via APIs, direct integration (e.g., into the computing environment of an enterprise) normally is not necessary.

In some embodiments, the threat detection platform 200 is programmed to build a separate machine learning (ML) model for each employee based on the retrospective information regarding the digital activities performed with the corresponding email account in order to better identify instances of email account compromise in near real time. For example, the threat detection platform 200 may ingest digital activities performed with an email account over the last six months, and then the threat detection platform may build an ML model that understands how the email account normally accesses the enterprise network, communicates internally (e.g., via internal email with other employees), or communicates externally (e.g., via external email with vendors). The ML model may help identify when the behavior of the email account has changed.

Such an approach allows the threat detection platform 200 to employ an effective ML model nearly immediately upon receiving approval from the enterprise to deploy it. Unlike conventional security products that only have access moving forward in time (i.e., after receiving the approval), the threat detection platform 200 may employ a backward-looking approach to develop ML models that are effective upon deployment. Such an approach also enables the threat detection platform to go through a repository of past digital activities to identify whether any email accounts should presently be suspected of compromise.

The aforementioned API-based approach provides a consistent way of looking at information related to the digital activities performed with email accounts belonging to employees of an enterprise. Because the threat detection platform 200 can directly access the emails (e.g., external emails and internal emails) transmitted and received by these email accounts, the threat detection platform 200 can examine the internal emails that are invisible to standard integration solutions. For example, an SEG integration that occurs through the mail exchanger (MX) record will only be able to see external emails arriving from, or destined for, external sources. The only way to make internal email visible to the SEG integration would be to externally reroute the email through the gateway.

The threat detection platform 200 may design/train the ML models to discover possible instances of email account compromise by examining the aggregated signals. As shown in FIG. 2, the threat detection platform 200 can parse the aggregated signals to identify compromise signals that indicate an email account may be compromised, and then the threat detection platform can determine the risk to the enterprise based on the compromise signals.

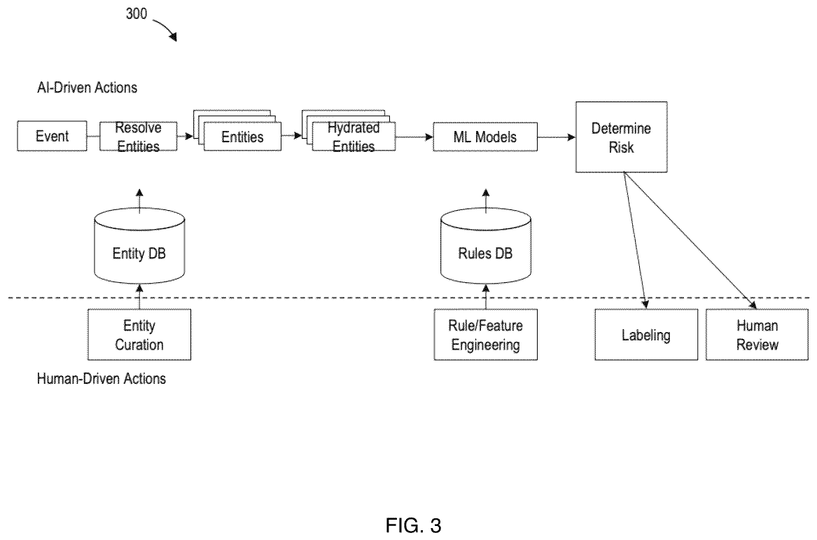

FIG. 3 is a block diagram of an embodiment of a threat detection platform. The diagram of FIG. 3 includes a subset of components of an embodiment of a threat detection platform and is used to help illustrate the process in which a threat detection platform identifies a compromise signal. In some embodiments, the threat detection platform 300 illustrated in FIG. 3 is the threat detection platform 100 of FIG. 1 and/or the threat detection platform 200 of FIG. 2.

Initially, the threat detection platform will determine a digital activity (also referred to as a “risk event” or “event”) has been performed. As discussed above, the threat detection platform may be programmatically integrated with storage medium(s) to obtain information regarding the digital activity. For example, the threat detection platform may be programmatically integrated with an email service employed by an enterprise so that all external emails and/or internal emails are routed through the threat detection platform for examination.

Then, the threat detection platform may perform an entity resolution procedure in order to identify the entities involved in the digital activity. Generally, the entity resolution procedure is a multi-step process. First, the threat detection platform will acquire information regarding the digital activity. For example, if the digital activity is the transmission of an email, the threat detection platform may examine the email to identify the recipient identity, recipient email address, subject, body content, etc. Moreover, the threat detection platform may be able to determine whether the email includes any links or attachments. Second, the threat detection platform will resolve entities involved in the digital activity by examining the acquired information. Some information may correspond directly to an entity. For example, the identity of the recipient may be established based on the recipient email address. Other information may correspond indirectly to an entity. For example, the identity of the recipient could be established by applying a natural language processing (NLP) algorithm and/or a computer vision (CV) algorithm to the body of the email. Further information regarding entity resolution can be found in Patent Cooperation Treaty (PCT) Application No. PCT/US2019/67279, titled “Threat Detection Platforms for Detecting, Characterizing, and Remediating Email-Based Threats in Real Time,” which is incorporated by reference herein in its entirety.

In some embodiments, the threat detection platform augments the acquired information with human-curated content. For example, information regarding the entities may be extracted from human-curated datasets of known vendors, domains, URLs, etc. These human-curated datasets may be used to augment the information gleaned from the enterprise's own data. Additionally or alternatively, humans may be responsible for labeling entities in some situations. For example, a human may be responsible for labeling the URLs of links found in emails.

The threat detection platform can examine the entities to determine whether any digital activities should be characterized as compromise signals (also referred to as “indicators of compromise”). The term “compromise signal,” as used herein, may refer to information related to a digital activity that indicates the corresponding email account may be compromised. One example of a compromise signal is a URL for a phishing page discovered in the body of an email. Another example of a compromise signal is a recipient email address that has not been contacted in the past.

If the threat detection platform discovers a compromise signal related to the digital activity, the threat detection platform can determine what remediation actions, if any, are appropriate as shown in FIG. 2. For example, the threat detection platform may notify a threat service (also referred to as a “security service”) that the email account may be compromised. As another example, the threat detection platform may notify the enterprise that the email account may be compromised. For instance, the notification may be delivered to an individual in the information technology (IT) department of the enterprise. Additionally or alternatively, the threat detection platform may automatically perform remediation actions based on the confidence level of the threat detection platform in its determination, the types of digital activities that prompted suspicion, or the threat posed by the compromise.

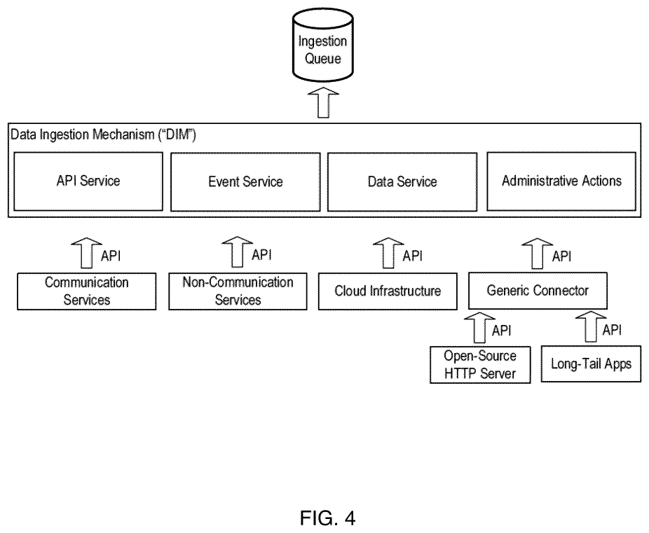

FIG. 4 is a block diagram illustrating an embodiment of a system for creating an event queue from events associated with various platforms. This example includes a high-level illustration of the architecture of a data ingestion mechanism (“DIM”) that could be implemented in the threat detection platform. In some embodiments, the threat detection platform of FIG. 4 is the threat detection platform 100 of FIG. 1, the threat detection platform 200 of FIG. 2, and/or the threat detection platform 300 of FIG. 3. As shown in this example, the DIM may support one or more APIs via which data can be ingested from various sources. Here, for example, the DIM supports APIs via which data can be acquired from SaaS services (e.g., those offered by Microsoft, Google, Salesforce, Workday, ServiceNow, Oracle, etc.) and cloud infrastructures (e.g., Google Cloud Platform, Amazon Web Services, and Microsoft Azure). In some embodiments, the DIM supports an API that serves as a generic data interface via which data can be provided to the threat detection platform in nearly any form, whether structured or unstructured. Via this API, data can be acquired from an open-source Hypertext Transfer Protocol (“HTTP”) server, on-premises computer programs (also called “long-tail computer programs” or “long-tail applications”), and the like. Because this “generic API” can serve as a connection mechanism between the threat detection platform and sources of data, it may also be called a “generic connection mechanism” or “generic connector.” Each API supported or accessed by the DIM may include—or interface with—a standardization mechanism that allows the data ingested from a corresponding service to be more readily handled by the various modules of the threat detection platform.

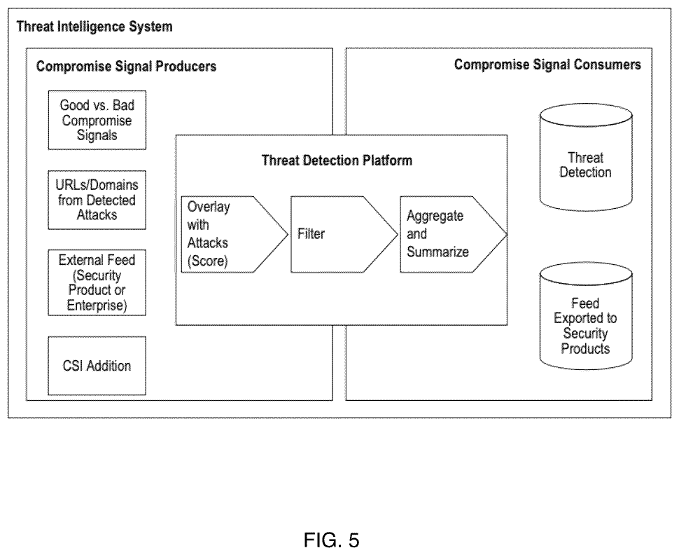

FIG. 5 is a diagram of an embodiment of a threat intelligence system that is utilized by a threat detection platform. The diagram of FIG. 5 illustrates examples of signals used by the threat detection platform to identify potential threats. In some embodiments, the threat detection platform of FIG. 5 is the threat detection platform 100 of FIG. 1, the threat detection platform 200 of FIG. 2, the threat detection platform of FIG. 3, and/or the threat detection platform of FIG. 4. As shown in the high-level diagram of FIG. 5, compromise signals can be produced, discovered, and/or inferred from several different types of data. These types of data include data related to include emails (e.g., incoming emails or outgoing emails), mail filters, and sign-in events.

In various embodiments, the threat detection platform may overlap the compromise signals with digital activities discovered, for example, by examining incoming and outgoing email. Thus, the threat detection platform may attempt to match the compromise signals with digital activities so that the score calculated for each digital activity can be attributed to the appropriate compromise signal(s). Thereafter, the threat detection platform may filter the compromise signals (e.g., based on the scores that have been attributed to them) and then use the filtered compromise signals to further bolster its ability to detect threats.

As discussed above, the threat detection platform may utilize its ecosystem of multiple enterprises to offer federated capabilities. For example, the threat detection platform could build a central database across its entire environment that includes a list of safe vendors and learn what constitutes normal behavior for each safe vendor. In particular, the central database may specify the email addresses used by each safe vendor, the individual(s) responsible for sending invoices for each safe vendor, the invoicing software used by each safe vendor, the routing/bank account numbers of each safe vendor, the location from which the invoices of each safe vendor originate, etc. As another example, the threat detection platform could build a central database across its entire environment that includes a list of entities that are notable in terms of the type, strength, or frequency of attacks by those entities. Examples of such entities may include IP addresses, URLs, domains, and email addresses. Such a central database may be helpful as it permits the threat detection platform to apply knowledge gained from one enterprise across the entire ecosystem.

Generally, the threat detection platform is designed so that datasets can be generated, processed, and added to the pipeline in which ML models are developed, trained, etc. Each dataset may be readily reproducible, updatable, searchable, or viewable. As noted above, the datasets may be edited through interfaces generated by the threat detection platform. For example, a human may label different compromise signals in a dataset for the purpose of training an ML model. Examples of databases that may be accessible to the threat detection platform include:
A vendor database that includes a set of vendors from which enterprises receive emails. Examples of vendors include American Express®, Chase®, Lloyd's Bank®, Microsoft®, etc. In the vendor database, each vendor may be associated with a canonical name, a list of safe domains (e.g., domains that emails link to, domains that emails are received from, domains with which the vendor works), a list of alias names, a list of common expressions (e.g., “Employee via Third-Party Service”), or appropriate signifiers. The threat detection platform may use the vendor database to whitelist and/or blacklist extracted signals.
A domain database that includes a set of top-level domains. For each domain, the threat detection platform can track additional information. For example, the threat detection platform may establish whether each domain has been whitelisted as a safe domain, whether the domain corresponds to a hosting service, whether the domain is a redirector, etc. Moreover, the domain database may specify what, if anything, Google's SafeBrowsing API says about the domain, how often the domain is included in emails received by the enterprise, how much labeled data can be seen, what cached Whois data is available for the domain, etc.
A Whois registrant database that includes information about each registrant derived from Whois data stored in the domain database.
A URL database that includes URL-level information derived from links included in emails received and/or transmitted by an enterprise. For each URL, the threat detection platform may populate an entry with a model indicative of URL suspiciousness, data regarding URL quality (e.g., data from phishtank.com), data acquired via Google's SafeBrowsing API, or statistics regarding how often the URL is seen in emails received and/or transmitted by the enterprise.
An employee database that includes information on the employees of an enterprise. Generally, the threat detection platform maintains a separate employee database for each enterprise whose security is being monitored. For each employee, the threat detection platform may populate an entry with an enterprise identifier, name, employee identifier, alias names, known email addresses (e.g., enterprise email addresses and personal email addresses that have been verified), Lightweight Directory Access Protocol (LDAP) role, the number of suspected attacks observed against the employee's email account, or the number of suspected attacks originated by the employee's email account.
A label database (also referred to as a “feedback database”) that includes labelled data to be used to build aggregated feedback for each enterprise, employee, etc. An entry could include aggregated feedback for an email address, domain, link, etc. For example, an entry in the label database may specify that 15 out of 30 emails from A@exploit.com have been labeled as positive for attacks, or that 10 out of 11 emails containing a link to http://xyz.com have been labeled as positive for attacks.

As discussed above, an enterprise may monitor compromise signals gleaned by the threat detection platform (e.g., from digital activities such as transmissions of intra-enterprise emails) to identify appropriate remediation actions, preventive measures, etc. By exposing compromise signals in a rapid manner, the threat detection platform can alert enterprises so that security postures can be improved to counteract the threat posed by a compromised email account. In some embodiments, the threat detection platform allows users to extract and/or export compromise signals. For example, an enterprise may export information (also referred to as “threat intelligence”) related to these compromise signals into a management tool to improve its ability to detect, identify, and address these threats in the future. The threat detection platform may format the information (e.g., into a machine-readable form) so that it is readily shareable. For example, the information may be formatted in accordance with the Structured Threat Information Expression (STIX) and Trusted Automated Exchange of Indicator Information (TAXII) specifications. Generally, STIX will indicate what type of threat intelligence is formatted, while TAXII will define how the underlying information is relayed.

A schema may be employed to ensure that threat intelligence is accounted for in a consistent manner. For a given digital activity, the schema may indicate:
An observable output (e.g., the email account at issue);
A compromise signal (e.g., the URL, IP address, domain, mail filter, or sign-in event under consideration);
A classification (e.g., whether the compromise signal is representative of a reimbursement scheme, fraud scheme, or theft scheme);
A severity (e.g., whether compromise of the email account poses a low, medium, high, or very high threat to the security of the enterprise);
A confidence metric (e.g., a score on a 0-100 scale indicating confidence that the compromise signal corresponds to evidence of email account compromise);
An observed time; and/or
A Traffic Light Protocol (TLP) metric indicating how widely the underlying information should be shared.

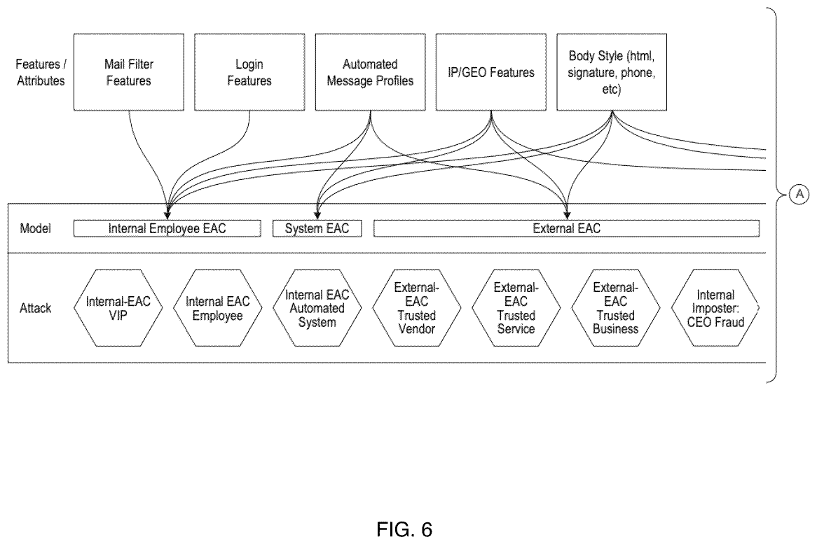

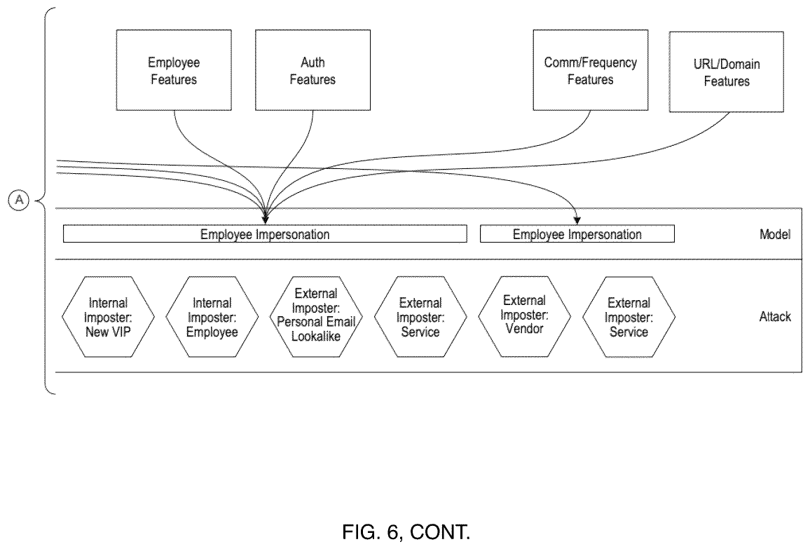

FIG. 6 is a block diagram of an embodiment of a threat detection platform for predicting attacks. The diagram of FIG. 6 includes a subset of components of an embodiment of a threat detection platform to illustrate how a threat detection platform may generate, derive, or infer attributes from data related to the digital activities performed with email accounts associated with employees of an enterprise, provide those attributes to ML models as input, and then examine the outputs produced by those ML models to determine whether the security of the enterprise is threatened. As shown in FIG. 6, the attributes could be provided as input to a variety of ML models associated with different types of attacks. Here, for example, features related to the sign-in events (also referred to as “login events”) of an email account could be fed into ML models designed to detect internal email account compromise. Based on the attack predicted from the input signals associated with an event, the appropriate computer security action can be performed. In some embodiments, the input features to the ML models are correlated inputs such as a combination of one or more input attributes. In some embodiments, the threat detection platform of FIG. 6 is the threat detection platform 100 of FIG. 1, the threat detection platform 200 of FIG. 2, the threat detection platform of FIG. 3, the threat detection platform of FIG. 4, and/or the threat detection platform of FIG. 5.

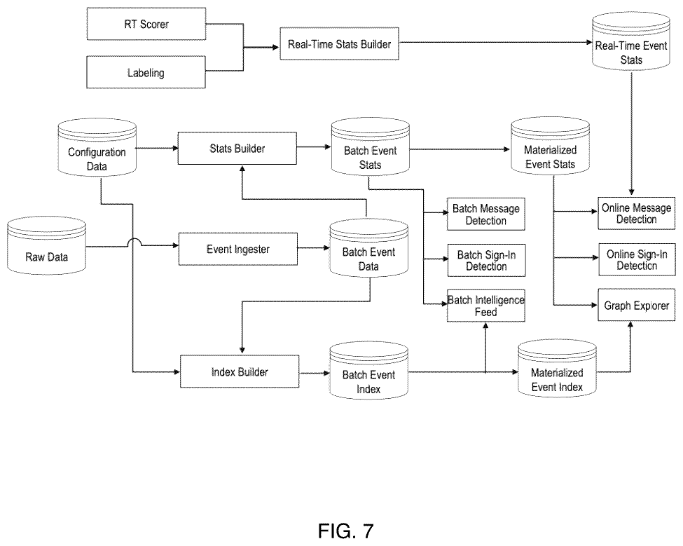

FIG. 7 is a block diagram of an embodiment of a threat detection platform for performing threat intelligence. The diagram of FIG. 7 includes a subset of components of an embodiment of a threat detection platform to illustrate at a high-level an embodiment of a process by which a threat detection platform can perform threat intelligence. In some embodiments, the threat detection platform of FIG. 7 is the threat detection platform 100 of FIG. 1, the threat detection platform 200 of FIG. 2, the threat detection platform of FIG. 3, the threat detection platform of FIG. 4, the threat detection platform of FIG. 5, and/or the threat detection platform of FIG. 6. As shown in FIG. 7, data can be obtained from several different sources. Here, the threat detection platform obtains configuration data and raw data. Configuration data may include instructions/rules that indicate whether the threat detection platform should “listen” for digital activities performed with a given email account. Meanwhile, raw data can include information pertaining to the digital activities performed with the given email account.

In some embodiments, the event ingester module (or simply “event ingester”) may be responsible for converting the raw data into an internal schema for digital activities (also referred to as “events”). The schema may be designed to hold various digital activities regardless of type (e.g., reception/transmission of email, sign-in event, creation of mail filter). The stats builder module (or simply “stats builder”) may be responsible for mapping attributes corresponding to an interval of time to counts of digital activities.

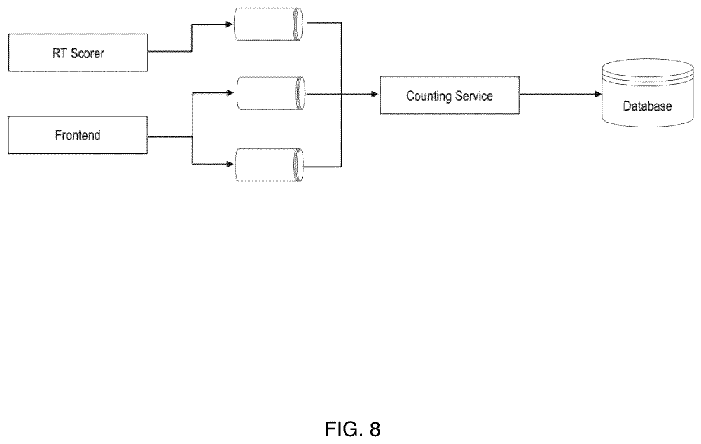

FIG. 8 is a block diagram of an embodiment of a threat detection platform for determining a potential threat. The diagram of FIG. 8 includes a subset of components of an embodiment of a threat detection platform to illustrate at a high-level an embodiment of a process for determining the threat posed by a user account. As shown, FIG. 8 illustrates at a high-level, an embodiment of a process by which a threat detection platform can “productionalize” a signature to be used to determine the threat posed by an email account. In some embodiments, the threat detection platform of FIG. 8 is the threat detection platform 100 of FIG. 1, the threat detection platform 200 of FIG. 2, the threat detection platform of FIG. 3, the threat detection platform of FIG. 4, the threat detection platform of FIG. 5, the threat detection platform of FIG. 6, and/or the threat detection platform of FIG. 7.

In various embodiments, initially, a real-time scoring module (also referred to as the “RT scorer”) can process raw data related to the digital activities of the email account. The processed data associated with each digital activity can be passed to a counting service (also referred to as a “counting system”) that converts the processed data into an event.

Moreover, each digital activity labeled through the frontend (e.g., via an interface generated by the threat detection platform) can be passed to the counting service, which converts the labeled digital activity into an event. The labels may indicate whether the digital activities represent a threat to the security of the enterprise with which the email account is associated. For example, the labels may indicate that sign-in events that occur in certain geographical locations are authentic (and thus should not be flagged as possible instances of email account compromise). Accordingly, the events derived from the labeled digital activities may be associated with a risk metric.

The events created by the counting service can be stored in a database (e.g., a Redis distributed database). This data may be formatted so that it can be easily queried for signatures. The term “signature,” as used herein, may refer to the combination of attributes (e.g., primary attributes and/or secondary attributes) associated with a digital activity that collectively define an event. Thus, queries could be submitted, for example, for signatures determined not to represent a threat, signatures having a given attribute (or combination of attributes), etc.

As discussed herein, a threat detection platform can be designed to discover potential instances of email account compromise in order to identify threats to an enterprise. To accomplish this, the threat detection platform may examine data related to the digital activities performed with email accounts corresponding to some or all of the employees of the enterprise. Examples of digital activities include the reception of an incoming email, transmission of an outgoing email, creation of a mail filter, an act of signing/logging into the email account, and identification of an identity risk event (e.g., as determined by Microsoft Office® 365). Accordingly, embodiments of the threat detection platform may examine data related to mail filters (e.g., by identifying the mail filters employees have set up to filter incoming email), identity risk events (e.g., by identifying the alerts created by Microsoft Office® 365), security alerts (e.g., by identifying the per-employee security alerts generated by Microsoft Office® 365), sign-in events (e.g., by identifying the geographical location of each sign-in event), and email-based attacks (e.g., by examining whether compromise signals are included in external emails and/or internal emails).

Thus, the threat detection platform may examine data related to a variety of digital activities performed with an email account in order to determine the likelihood that the email account has been compromised. Such an approach enables the threat detection platform to detect instances of email account compromise more quickly, accurately, and consistently.

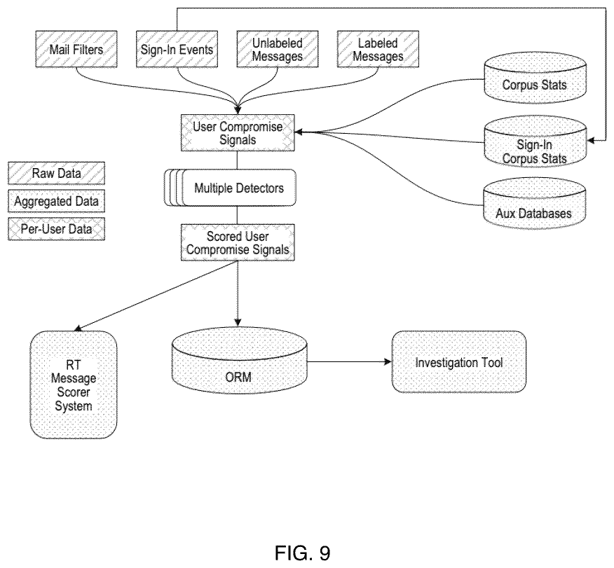

FIG. 9 is a block diagram of an embodiment of a threat detection platform for detecting potential instances of account compromise. The diagram of FIG. 9 includes a subset of components of an embodiment of a threat detection platform to illustrate at a high-level an embodiment of a process for detecting threats deviations to learned behaviors. In some embodiments, the threat detection platform of FIG. 9 is the threat detection platform 100 of FIG. 1, the threat detection platform 200 of FIG. 2, the threat detection platform of FIG. 3, the threat detection platform of FIG. 4, the threat detection platform of FIG. 5, the threat detection platform of FIG. 6, the threat detection platform of FIG. 7, and/or the threat detection platform of FIG. 8.

In various embodiments, at a high level, the threat detection platform can learn what behaviors should be considered normal on a per-employee or per-enterprise basis by identifying behavioral traits (e.g., where sign-in events occur, when emails are generated, who emails are addressed to) and then employing personalized learning to discover deviations in these behaviors. Here, for example, the threat detection platform examines raw data (e.g., in the form of mail filters, sign-in events, unlabeled messages, and labeled messages) and aggregated data (e.g., in the form of corpus statistics, sign-in corpus statistics, and auxiliary databases) to discover signals that indicate the email account may be compromised. Generally, these “compromise signals” correspond to deviations in the behaviors of the email account under examination.

As shown in the example of FIG. 9, the threat detection platform can employ one or more detectors to score each compromise signal. Each score may be representative of how highly the compromise signal corresponds to the likelihood that the email account has been compromised. Accordingly, compromise signals may be discovered and scored on a per-employee basis.

In various embodiments, the threat detection platform can detect instances of compromise by comparing digital activities involving a given email account to the scored compromise signals and/or a profile built from past digital activities. For instance, the threat detection platform may discover, based on the location and/or frequency of sign-in events, that an email account may have become compromised. As an example, assume that the threat detection platform discovers that a sign-in event for a given email account has occurred in San Francisco, California, at 7:05 PM. If the threat detection platform discovers that the given email account is then involved in another sign-in event in Chicago, Illinois, at 7:30 PM, the threat detection platform may identify the given email account as possibly compromised.

Note, however, that the threat detection platform need not necessarily take action immediately. For instance, the threat detection platform may determine what remediation actions, if any, to take based on which compromise signals indicate abnormal behavior, the scores of those compromise signals, etc. As an example, the threat detection platform may take immediate action to prevent further accesses of the email account if the relevant compromise signal(s) have high scores, but the threat detection platform may simply continue to monitor the email account if the relevant compromise signal(s) have low scores.

Such an approach allows the threat detection platform to infer whether an email account has been compromised based on the digital activities performed with that email account. In some embodiments, the threat detection platform employs a set of heuristics that has been trained using a series of training emails that have been labelled as malicious (e.g., by the enterprise or security service). These training emails may be fictional examples or actual examples of past emails generated by compromised email accounts. When applied to emails generated by an email account, the set of heuristics can be helpful in determining the riskiness of a given email based on its content and context.

Instances of email account compromise (as well as the digital activity that caused concern) may be surfaced to an investigation tool for review. This could be done continually (e.g., as the digital activity is processed and scored) or periodically (e.g., every 3, 6, 12, or 24 hours). Each potential instance of email account compromise can be reviewed by an individual, who may use information not available to the threat detection platform (e.g., information regarding the employee such as vacation details) to make a final determination.

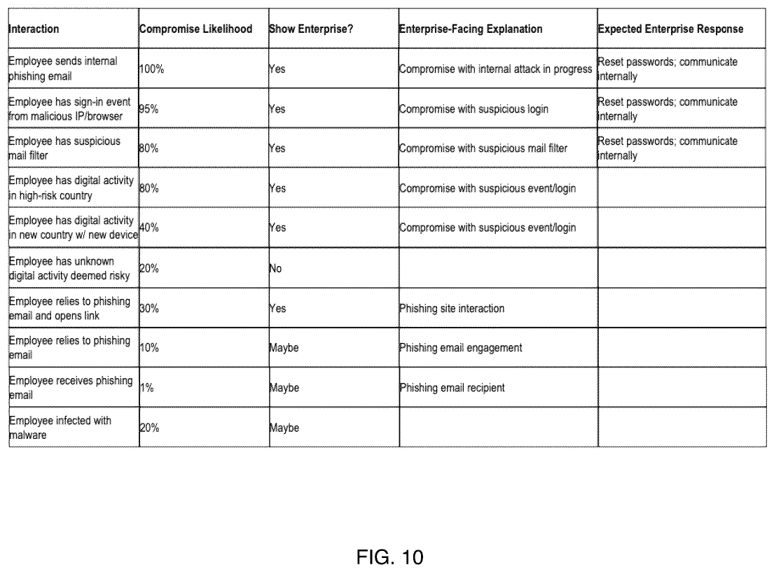

FIG. 10 is a diagram of example computer security actions that can be made by an embodiment of a threat detection platform. The example matrix shown in FIG. 10 includes example decisions that may be made by a threat detection platform as it discovers compromise signals corresponding to digital activities. Other computer security actions can be performed as well but are not shown. For example, the login event can be blocked, the user account can be suspended, the user account can be required to set up new login credentials such as a new MFA device, an existing MFA device can be revoked, an access token such as an Open Authentication (OAuth) token can be revoked, access to resources such as network resources can be restricted, and/or existing user sessions can be invalidated requiring the user to reauthenticate to gain access, among other security actions. In some embodiments, the threat detection platform of FIG. 10 is the threat detection platform 100 of FIG. 1, the threat detection platform 200 of FIG. 2, the threat detection platform of FIG. 3, the threat detection platform of FIG. 4, the threat detection platform of FIG. 5, the threat detection platform of FIG. 6, the threat detection platform of FIG. 7, the threat detection platform of FIG. 8, and/or the threat detection platform of FIG. 9.

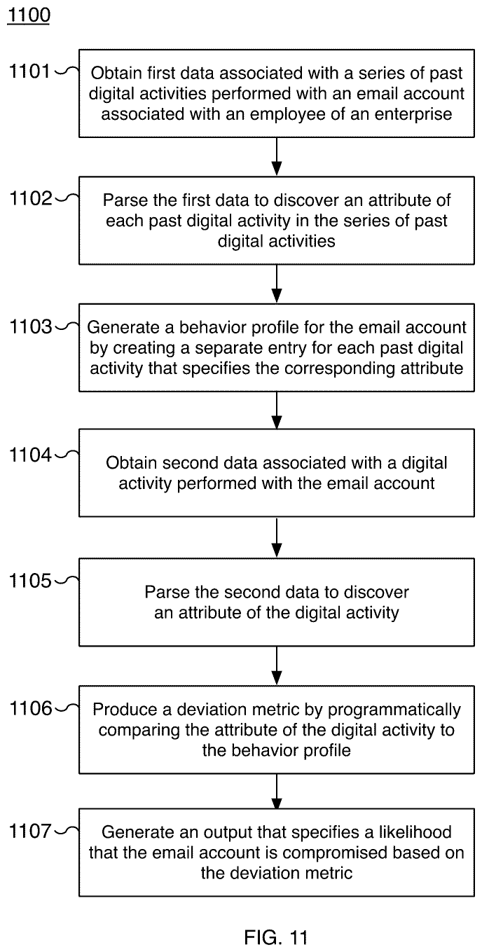

FIG. 11 is a flow chart illustrating an embodiment of a process for determining that an account has been compromised. For example, the process 1100 of FIG. 11 can be performed by a threat detection platform to determine the likelihood that an email account belonging to an employee of an enterprise has been compromised. In some embodiments, process 1100 is performed by a threat detection platform such as the threat detection platform 100 of FIG. 1, the threat detection platform 200 of FIG. 2, and/or the threat detection platforms of FIGS. 3-9.

At 1101, a first set of data (“first data”) associated with a series of past digital activities performed with an email account associated with an employee of an enterprise is obtained. As discussed above, the first data may be obtained from a storage medium via an API. In embodiments where the first data is distributed amongst multiple storage mediums, the threat detection platform may establish a separate connection with each storage medium via a corresponding API. The series of past digital activities can include receptions of incoming emails, transmissions of outgoing emails, creations of mail filters, and/or occurrences of sign-in events. Generally, the first data corresponds to a recent past interval of time (e.g., the last 3, 6, or 12 months), but the first data could correspond to any past interval of time.

At 1102, the first data is parsed to discover an attribute of each past digital activity in the series of past digital activities. The attribute may be a primary attribute or a secondary attribute. For example, for the transmission of an outgoing email, the threat detection platform may identify the email address of each recipient. As another example, for the occurrence of a sign-in event, the threat detection platform may identify the time and/or geographical location of the sign-in event.

At 1103, a behavior profile (also referred to as a “historical profile” or “communication profile”) for the email account is generated by creating a separate entry for each past digital activity that specifies the corresponding attribute. In some embodiments, the behavior profile is representative of a series of predefined schemas that have been populated based on the first data. In such embodiments, the threat detection platform may examine the first data to identify the information related to each past digital activity, and then the threat detection platform may define each past digital activity as a separate event by populating a predefined schema with the corresponding information. The predefined schema may be designed to accommodate various types of digital activities.

At 1104, a second set of data (“second data”) associated with a digital activity performed with the email account is obtained. Generally, the second data is obtained in real time while, or shortly after, the digital activity is being performed so that the threat detection platform can take preventive action if necessary.

At 1105, the second data is parsed to discover an attribute of the digital activity. For example, the threat detection platform may identify the email address of each recipient if the digital activity is the transmission of an outgoing email, and the threat detection platform may identify the time and/or geographical location if the digital activity is the occurrence of a sign-in event.

At 1106, a deviation metric is produced by programmatically comparing the attribute of the digital activity to the behavior profile. More specifically, the threat detection platform may programmatically compare the attribute of the digital activity to the attributes listed in some or all of the entries in the behavior profile. For example, the threat detection platform may only programmatically compare the attribute of the digital activity to entries in the behavior profile that correspond to the same type of digital activity. Thus, attributes of sign-in events may be compared to attributes of past sign-in events, attributes of outgoing emails may be compared to attributes of past outgoing emails, etc. Any deviations may be provided to an ML model trained to determine whether the deviations are representative of email account compromise.

At 1107, an output that specifies a likelihood that the email account is compromised is generated based on the deviation metric. In some embodiments, the output is generated based on the deviation metric and/or the digital activity itself. The output can be handled by the threat detection platform in a variety of different ways. For example, the threat detection platform may transmit a notification to the employee or an administrator associated with the enterprise responsive to determining that the digital activity represents a particular type of compromise scheme. As another example, the threat detection platform may automatically determine an appropriate remediation action to perform on behalf of the enterprise responsive to determining that the likelihood of compromise exceeds a threshold. The threshold may be part of a series of thresholds representative of different levels of risk to the enterprise.

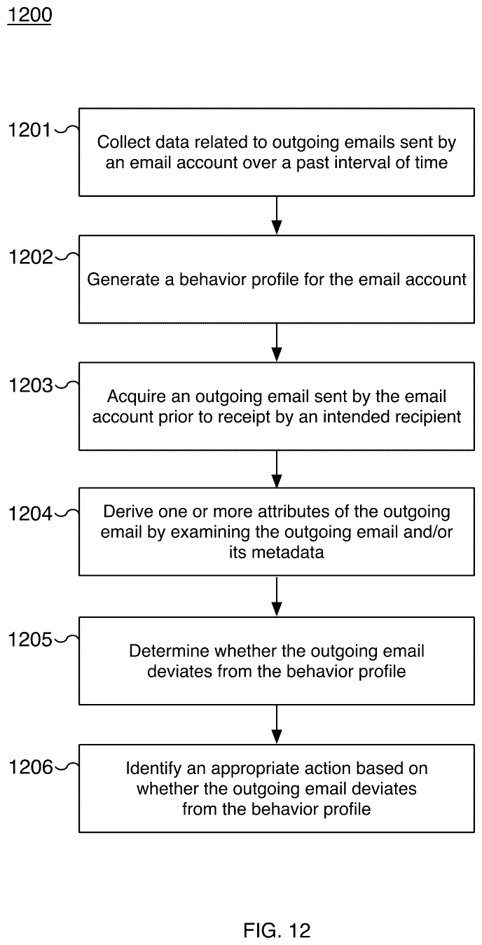

FIG. 12 is a flow chart illustrating an embodiment of a process for determining that an account has been compromised. For example, the process 1200 of FIG. 12 can be performed by a threat detection platform to determine the likelihood that an email account has been compromised based on the content and/or context of outgoing emails produced by the email account. In some embodiments, the process is performed by a threat detection platform such as the threat detection platform 100 of FIG. 1, the threat detection platform 200 of FIG. 2, and/or the threat detection platforms of FIGS. 3-9.

At 1201, data related to outgoing emails sent by an email account over a past interval of time is collected. As discussed above, the data may be collected directly from the enterprise or a service used by the enterprise (e.g., Microsoft Office® 365).

At 1202, a behavior profile for the email account is generated. For example, the threat detection platform may derive at least one attribute of each outgoing email from the data and then populate a data structure that represents the behavior profile with the derived attributes. These attributes can include the geographical origin, sender identity, sender email address, recipient identity, recipient email address, subject, body, attachments, etc. Moreover, the threat detection platform can establish patterns and/or traits that the email account consistently exhibits. For example, the threat detection platform may determine whether the email account consistently uses the same signature or formatting. As another example, the threat detection platform may determine whether the email account ever leaves subject lines blank or inserts links into the body without any context.

At 1203, an outgoing email sent by the email account prior to receipt by an intended recipient is acquired. Generally, the outgoing email is acquired prior to receipt by the intended recipient(s) although in some situations, the outgoing email may be acquired after receipt by the intended recipient(s). Accordingly, the threat detection platform may divert some or all outgoing email into a quarantine folder for examination.

At 1204, one or more attributes of the outgoing email are derived by examining the outgoing email and/or its metadata. For example, the threat detection platform may identify the email addresses of all intended recipients, or the threat detection platform may identify any URLs (or links to URLs) embedded in the body of the outgoing email or an attachment.

At 1205, whether the outgoing email deviates from the behavior profile for the email account is determined. For example, the threat detection platform may programmatically compare the one or more attributes to each entry in the data structure corresponding to a past outgoing email.

At 1206, an appropriate action based on whether the outgoing email deviates from the behavior profile is identified. If the threat detection platform determines that the outgoing email does not deviate from the behavior profile, then the threat detection platform may forward the outgoing email to a mail server or a corporate mail system for transmission to the intended recipient(s). However, if the threat detection platform determines that the outgoing email does deviate from the behavior profile, then the threat detection platform may identify the email account as possibly being compromised. For example, the threat detection platform may notify an administrator that the email account may be compromised. The administrator may be associated with an enterprise responsible for managing the email account or a security service employed by the enterprise. As discussed above, in some embodiments the threat detection platform enables the administrator to manually address the threat posed by the email account, while in other embodiments the threat detection platform automatically addresses the threat posed by the email account on behalf of the administrator.

Unless contrary to possibility, these steps could be performed in various sequences and combinations. For example, a threat detection platform may be designed to address the threat posed by a compromised email account by performing a remediation action and notify an administrator of the compromised email account so that manual action can also be taken.

Other steps could also be included in some embodiments. For example, the processes 1100, 1200 of FIGS. 11-12 may be continuously or periodically performed over time so that the behavior profile is updated as digital activities are performed with the email account. This ensures that the threat detection platform can account for small adjustments in the behavior of the email account over time without generating false positives. Said another way, adjusting the behavior profile over time ensures that the threat detection platform is less likely to determine that the email account is compromised due to abnormal behavior when it is not actually compromised. As another example, all digital activities performed with an email account under investigation for possible compromise may be scored and, in some instances, attached to the file maintained for the investigation. Further information on scoring digital activities can be found in Patent Cooperation Treaty (PCT) Application No. PCT/US2019/67279.

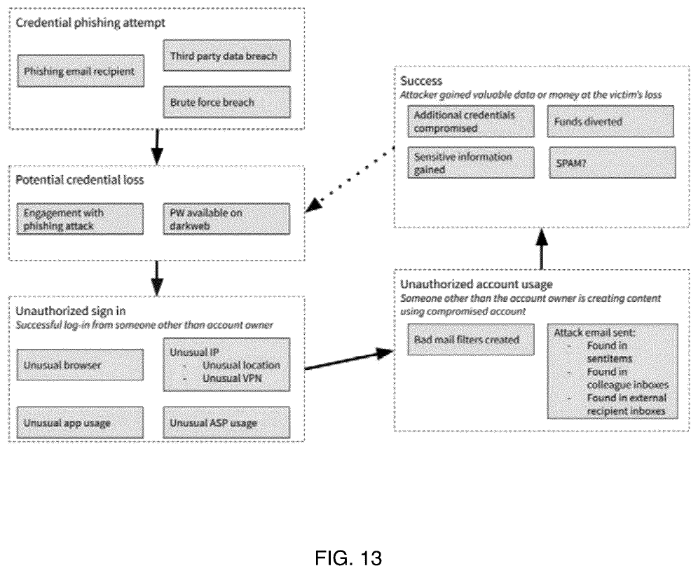

FIG. 13 is a block diagram illustrating a framework for an embodiment of a threat detection platform for discovering instances of email account compromise. For example, the framework illustrated by FIG. 13 can be used to identify instances of email account compromise on behalf of enterprises (also referred to as “customers”). In some embodiments, the process is performed by a threat detection platform such as the threat detection platform 100 of FIG. 1, the threat detection platform 200 of FIG. 2, and/or the threat detection platforms of FIGS. 3-9.

In various embodiments, since enterprises may have different appetites for the information regarding possible instances of email account compromise, the threat detection platform may be designed to create easily understandable menus through which enterprises can specify the amount of information that is desired. For example, a first enterprise (“Client A”) may have set their account to create alerts for all potential losses of credentials for email accounts and successful attacks discovered by the threat detection platform. However, a second enterprise (“Client B”) may have set their account to only create alerts for instances of unauthorized email account usage. The threat detection platform may also be designed to offer readily understandable summaries of the threat state. These summaries may be based on the preferences specified by each enterprise through the menus. Here, for example, summaries for Client A may include more detailed information than summaries for Client B since Client A has indicated a greater interest in knowing the threat state.

Some information retrieval mechanisms are not good at retrieving various types of data and then simultaneously or sequentially processing jobs that rely on this data. One benefit of a more flexible information retrieval mechanism is that the threat detection platform can more easily prioritize certain employees (e.g., recipients of phishing messages). Ideally, this flexible information retrieval mechanism should be able to quickly retrieve information related to all digital activities performed with a given email account, regardless of where that information is located, the types of digital activities, etc.

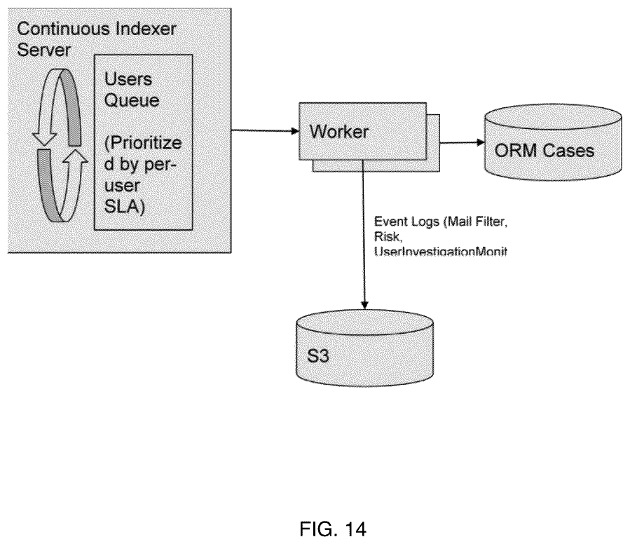

FIG. 14 is a block diagram illustrating an embodiment of a continuous indexer server for a threat detection platform. In various embodiments, a continuous indexer server performs its function for a threat detection platform. In some embodiments, the threat detection platform is the threat detection platform 100 of FIG. 1, the threat detection platform 200 of FIG. 2, and/or the threat detection platforms of FIGS. 3-9 and/or 13. In various embodiments, the continuous indexer server may be an always-on server that iterates through a set of employees that the threat detection platform wants to fetch digital activities for. Iteration may be done in order of priority (e.g., based on priority measured assigned by the threat detection platform). Priority may be based on the time at which each employee is identified by the threat detection platform, or priority may be based on the volume, nature, or type of digital activities that prompted the threat detection platform to become interested in each employee.

Each employee may be considered a work item by the continuous indexer server. Each work item may be queued with a fetch time and then dequeued by the conclusion of that fetch time. The fetch time defines the interval of time for which information regarding digital activities is retrieved for examination. The fetch time may be determined based on the likelihood that the email account has been compromised. For example, employees who have received phishing messages may be watched for 15 minutes, while regular employees (i.e., those employees who are not involved in any known risk events) may be watched for 120 minutes.

The continuous indexer server can be sharded by hash (e.g., employee identifier) to distribute work items among “N” servers. For example, if the threat detection platform is interested in examining the digital activities performed with 12 email accounts, then 4 work items may be distributed to a first server, 4 work items may be distributed to a second server, and 4 work items may be distributed to a third server. Note, however, that each server need not necessarily be assigned the same number of work items. For example, the distribution of work items may depend on the fetch times associated with those work items.

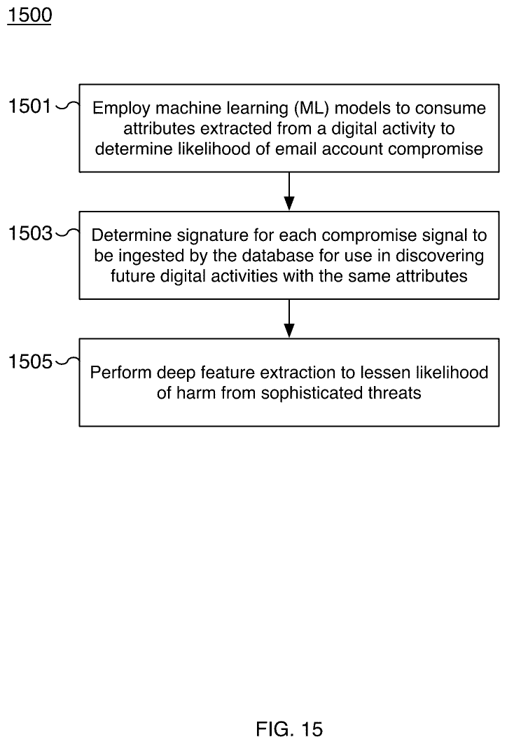

FIG. 15 is a flow chart illustrating an embodiment of a process for scoring a threat posed by a digital activity. For example, the process 1500 of FIG. 15 can be performed by a threat detection platform to score the threat posed by a digital activity, such as the transmission of an outgoing email. In some embodiments, process 1500 is performed by a threat detection platform such as the threat detection platform 100 of FIG. 1, the threat detection platform 200 of FIG. 2, and/or the threat detection platforms of FIGS. 3-9 and/or 13. As described herein, the term “accurate scoring” covers a combination of several concepts.

At 1501, one or more machine learning (ML) models, such as deep learning models, are employed to consume the attributes that have been extracted for a digital activity to determine the likelihood of an email account compromise. Collectively, these ML model(s) may be referred to as the “ML detector.” In some embodiments, a real-time proportional-integral-derivative (PID) controller is used to tune the threshold for each enterprise (or each employee) whose emails are being monitored to take into consideration the changing landscape of attack types, email content, etc. The thresholds ensure that the ML model(s) have high precision and continue to be highly precise over time. To cover the general attack landscape, the threat management platform may employ a combination of federated ML models, enterprise-specific ML models, and employee-specific ML models able to capture the nuances of sophisticated attacks (e.g., phishing attacks in internal emails generated by compromised email accounts).

At 1503, the signature for each compromise signal to be ingested by the database for use in discovering future digital activities with the same attributes is determined. In some embodiments, the signatures of compromise signals are determined in real time to determine the nature of any security threats identified by the ML detector. Examples of compromise signals include IP addresses, email addresses, URLs, domains, cryptocurrency addresses, etc. For zero-hour attacks, the compromise signals can be extracted as the digital activities are identified, processed, and classified by the ML detector. These compromise signals can be automatically ingested into the database as “signatures” in real time. Thereafter, the signatures can be used in conjunction with the ML detector to discover future digital activities with the same attributes.

At 1505, deep feature extraction is performed to lessen the likelihood of harm from sophisticated threats. For example, in some embodiments, the threat detection platform can perform deep feature extraction to identify zero-hour attacks. Identifying zero-hour attacks requires deeper content analysis to understand the nuances of possible attacks. For example, deep learning sub-model(s) may be applied to understand the text, content, sentiment, and/or tone of an email. As another example, to find phishing pages, computer vision may be used to compare a landing page of a link embedded in an email to a set of known sign-on pages. As another example, webpage crawling may be performed to extract information regarding a deep link (e.g., a link embedded in an attachment or a link accessible on a linked website) to discover instances of deep phishing.

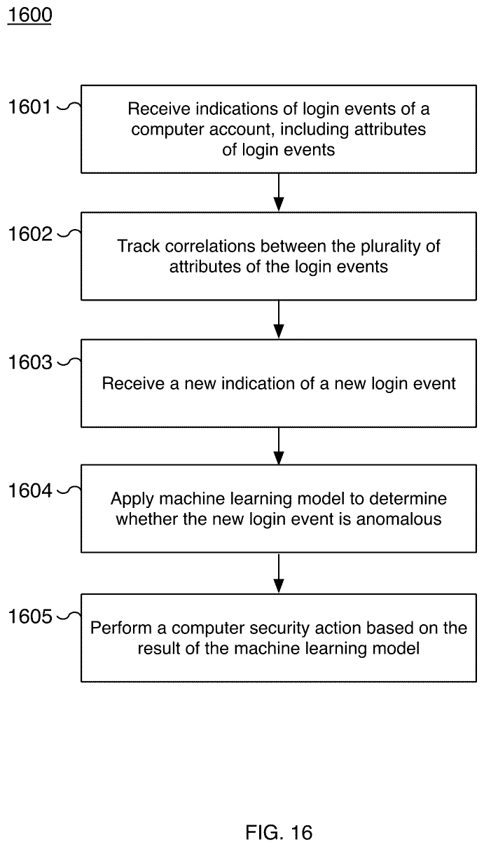

FIG. 16 is a flow chart illustrating an embodiment of a process for detecting an account takeover. For example, the process 1600 of FIG. 16 can be performed by a threat detection platform to detect and respond to a compromised user account that has been taken over by a malicious actor. In various embodiments, an anomalous event, such as a malicious login or sign-in event, is detected by predicting that the event is an anomaly. The prediction result can be determined using a machine learning model trained on learned normal behavior. In some embodiments, the process is performed by a threat detection platform such as the threat detection platform 100 of FIG. 1, the threat detection platform 200 of FIG. 2, and/or the threat detection platforms of FIGS. 3-9 and/or 13.

At 1601, indications of login events of a computer account, including attributes of login events, are received. For example, account related events including login events are monitored and indications of these events are ingested. The ingested event information can include attributes of the events such as information related to the location, IP address, ISP, MFA device, and/or access token of the event. In some embodiments, the event information includes age and/or frequency information of event information, such as the age of an MFA device or access token. In various embodiments, the ingested data can include audit logs and/or other logs or data with event information.

At 1602, correlations between the plurality of attributes of the login events are tracked. For example, the input signals associated with event information attributes are tracked along with correlations of the different input signals and their attributes. The correlations of attributes can include the combination of two or more attributes such as <IP address, MFA device>, <IP address, country, MFA device>, and <ISP, subnetwork, access token>, among others. In some embodiments, the tracked data is stored in a distributed hash map or another appropriate data structure. Moreover, the attributes and their correlations can be monitored, tracked, and stored according to various different windows or periods of time, such as recent past intervals of time corresponding to the last 7 days, 20 days, 30 days, 1 month, 3 months, 6 months, and/or 12 months. Based on tracked attributes, trends and/or patterns established by the user can be determined.

At 1603, a new indication of a new login event is received. For example, a new login event is identified for a user account. A new indication of the event is created and received by the threat detection platform. In various embodiments, the new indication includes event information including input signals associated with event information attributes, such as the attributes associated with the location, ISP, IP address, other network information, MFA, access token, etc. of the login event.

At 1604, a machine learning model is applied to determine whether the new login event is anomalous. For example, one or more machine learning (ML) models are trained and used to predict whether the new login event is anomalous. In various embodiments, an ML model can be trained to learn normal user and/or account behavior using the attribute data received at 1601 and tracked at 1602. Based at least in part on the tracked correlations and attributes of the new login event information received at 1603, an ML model can be used to determine a result associated with whether the corresponding new login event is anomalous. For example, event attribute data including correlation data can be used as input features for an ML model to predict whether the new login event is anomalous and represents malicious behavior such as an account takeover of a compromised account. In some embodiments, the correlation data used as input features corresponds to combinations of two or more event attributes such as <IP address, MFA device>, <IP address, country, MFA device>, and <ISP, subnetwork, access token>, among others.

At 1605, a computer security action based on the result of the machine learning model is performed. For example, a computer security action is performed to minimize the impact of the detected anomalous event. In some embodiments, the prediction result may further include detailed information on the anomaly and direct performing one or more particular security actions. In some embodiments, different security actions can be configured as responses. The performed computer security action(s) can include one or more of many actions including remediation and/or preventative security actions. For example, the login event can be blocked, access to the computer account can be suspended, a password change can be required, the user account can be suspended, the user account can be required to set up new login credentials such as a new password and/or new MFA device, an existing MFA device can be revoked, an access token such as an Open Authentication (OAuth) token can be revoked, access to resources such as network resources can be restricted, and/or existing user sessions can be invalidated requiring the user to reauthenticate to gain access, among other security actions.

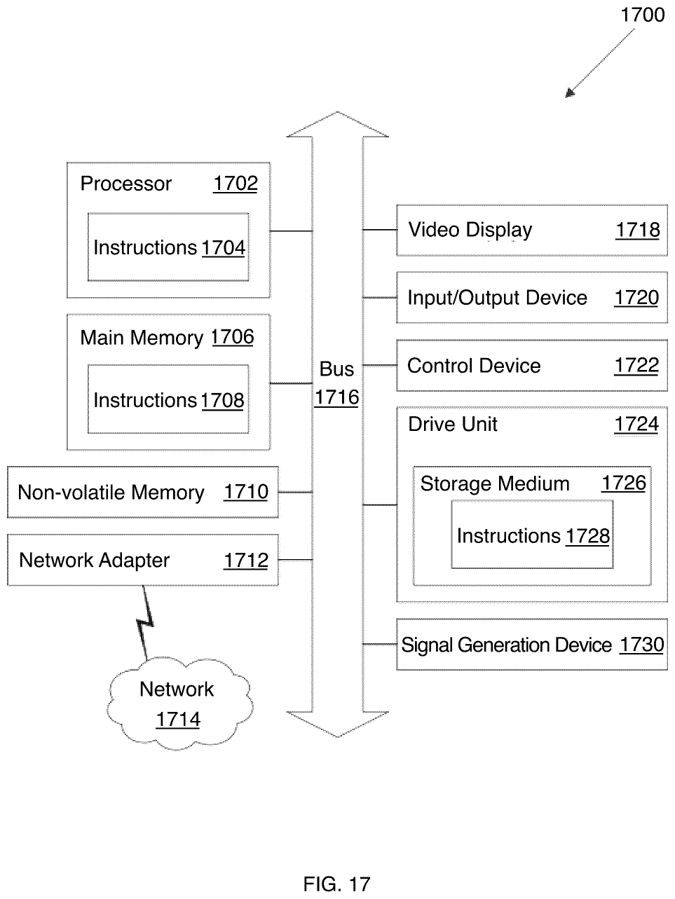

FIG. 17 is a functional diagram illustrating a programmed computer processing system for performing threat detection and remediation. As will be apparent, other computer system architectures and configurations can be utilized for performing threat detection and remediation including for performing account takeover detection. In various embodiments, FIG. 17 illustrates an example of a processing system 1700 in which at least some operations described herein can be implemented. For example, some components of the processing system 1700 may be hosted on a computing device that includes a threat detection platform (e.g., threat detection platform 100 of FIG. 1). As another example, some components of the processing system 1700 may be hosted on a computing device that is queried by a threat detection platform to acquire emails, data, etc. Examples of processing system 1700 include the threat detection platform 100 of FIG. 1, the threat detection platform 200 of FIG. 2, and/or the threat detection platforms of FIGS. 3-9 and/or 13. In various embodiments, one or more instances of processing system 1700 can be used to implement at least portions of the processes of FIGS. 11, 12, 15, and/or 16 and the functionality associated with the diagrams of FIGS. 10 and 14.

The processing system 1700 may include one or more central processing units (“processors”) 1702, main memory 1706, non-volatile memory 1710, network adapter 1712 (e.g., network interface), video display 1718, input/output devices 1720, control device 1722 (e.g., keyboard and pointing devices), drive unit 1724 including a storage medium 1726, and signal generation device 1730 that are communicatively connected to a bus 1716. The bus 1716 is illustrated as an abstraction that represents one or more physical buses and/or point-to-point connections that are connected by appropriate bridges, adapters, or controllers. The bus 1716, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1700 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1700.

While the main memory 1706, non-volatile memory 1710, and storage medium 1726 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1728. The terms “machine-readable medium” and “storage medium” shall also be taken to include any medium that is capable of storing, encoding, or carrying a set of instructions for execution by the processing system 1700.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1704, 1708, 1728) set at various times in various memory and storage devices in a computing device. When read and executed by the one or more processors 1702, the instruction(s) cause the processing system 1700 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1710, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1712 enables the processing system 1700 to mediate data in a network 1714 with an entity that is external to the processing system 1700 through any communication protocol supported by the processing system 1700 and the external entity. The network adapter 1712 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1712 may include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The programmed computer processing system shown in FIG. 17 is but an example of a processing system suitable for use with the various embodiments disclosed herein. Other computer processing systems suitable for such use can include additional or fewer subsystems. In addition, bus 1716 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving indications of login events of a computer account, including a plurality of attributes of the login events;
tracking correlations between the plurality of attributes of the login events;
receiving a new indication of a new login event;
based at least in part on the tracked correlations and attributes of the new login event, using a machine learning model to determine a result associated with whether the new login event is anomalous; and
performing a computer security action based on the result of the machine learning model.

2. The method of claim 1, wherein the plurality of attributes of the login events includes at least a location attribute of the computer account or a networking attribute of the computer account.

3. The method of claim 2, wherein the location attribute of the computer account includes at is least a city attribute, a state attribute, a country attribute, a region attribute, or a geographical coordinates attribute.

4. The method of claim 2, wherein the networking attribute of the computer account includes at least an Internet Protocol address attribute, an Internet Service Provider attribute, or a subnetwork attribute.

5. The method of claim 1, wherein the plurality of attributes includes one or more attributes associated with a multi-factor authentication device or an access token.

6. The method of claim 1, wherein at least one of the plurality of attributes is tracked using an age metric or a frequency metric.

7. The method of claim 1, wherein the tracked correlations are stored using a distributed hash map data structure.

8. The method of claim 1, wherein the tracked correlations are stored according to one or more intervals of time.

9. The method of claim 8, wherein at least one of the one or more intervals of time corresponds to a time of 7 days, 1 month, 3 months, 6 months, or 12 months.

10. The method of claim 1, wherein the computer security action corresponds to blocking the new login event, suspending the computer account, requiring a password change, requiring a new multi-factor authentication device, revoking an existing multi-factor authentication device, revoking an access token, restricting access to network resources, or invalidating one or more existing user sessions.

11. A system, comprising:
one or more processors; and
a memory coupled to the one or more processors, wherein the memory is configured to provide the one or more processors with instructions which when executed cause the one or more processors to:
receive indications of login events of a computer account, including a plurality of attributes of the login events;
track correlations between the plurality of attributes of the login events;
receive a new indication of a new login event;
based at least in part on the tracked correlations and attributes of the new login event, use a machine learning model to determine a result associated with whether the new login event is anomalous; and
perform a computer security action based on the result of the machine learning model.

12. The system of claim 11, wherein the plurality of attributes of the login events includes at least a location attribute of the computer account or a networking attribute of the computer account.

13. The system of claim 12, wherein the location attribute of the computer account includes at least a city attribute, a state attribute, a country attribute, a region attribute, or a geographical coordinates attribute.

14. The system of claim 12, wherein the networking attribute of the computer account includes at least an Internet Protocol address attribute, an Internet Service Provider attribute, or a subnetwork attribute.

15. The system of claim 11, wherein the plurality of attributes includes one or more attributes associated with a multi-factor authentication device or an access token.

16. The system of claim 11, wherein at least one of the plurality of attributes is tracked using an age metric or a frequency metric.

17. The system of claim 11, wherein the tracked correlations are stored using a distributed hash map data structure.

18. The system of claim 11, wherein the tracked correlations are stored according to one or more intervals of time.

19. The system of claim 1, wherein the computer security action corresponds to blocking the new login event, suspending the computer account, requiring a password change, requiring a new multi-factor authentication device, revoking an existing multi-factor authentication device, revoking an access token, restricting access to network resources, or invalidating one or more existing user sessions.

20. A computer program product, the computer program product being embodied in a non-transitory computer readable storage medium and comprising computer instructions for:
receiving indications of login events of a computer account, including a plurality of attributes of the login events;
tracking correlations between the plurality of attributes of the login events;
receiving a new indication of a new login event;
based at least in part on the tracked correlations and attributes of the new login event, using a machine learning model to determine a result associated with whether the new login event is anomalous; and
performing a computer security action based on the result of the machine learning model.
